(19) United States
(12) Patent Application Publication
(10) Pub. No.: US 2026/0281704 A1
(43) Pub. Date: Sep. 17, 2026

(54) CONFIGURATION OF NARROWBAND FILTERS FOR BACKSCATTERING COMMUNICATIONS

(71) Applicant: QUALCOMM Incorporated, San Diego, CA (US)

(72) Inventors: Luanxia YANG, Beijing (CN); Xiaoxia ZHANG, San Diego, CA (US); Junyi LI, Greentown, PA (US)

(21) Appl. No.: 19/168,224

(22) PCT Filed: May 1, 2023
(86) PCT No.: PCT/CN2023/091929

§ 371 Date: Sep. 23, 2025

(51) Int. Cl. H04W 8/24; H04W 52/02

(52) U.S. Cl. CPC H04W 8/24; H04W 52/0225

(57) ABSTRACT

Various aspects of the present disclosure generally relate to wireless communication. In some aspects, a user equipment (UE) may transmit an indication of a filtering capability of the UE. The UE may receive, based at least in part on the filtering capability, a configuration of one or more narrowband filters of the UE for backscattering communications. Numerous other aspects are described.

### FIELD OF THE DISCLOSURE

Aspects of the present disclosure generally relate to wireless communication and to techniques and apparatuses for configuring narrowband filters for backscattering communications.

### BACKGROUND

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and types of wireless communications mediums available for use, and the like. Consequently, there exists a need for further improvements in wireless communications systems to overcome the aforementioned technical challenges and others.

### SUMMARY

One aspect provides a method for wireless communication by a user equipment (UE). The method includes transmitting an indication of a filtering capability of the UE. The method includes receiving, based at least in part on the filtering capability, a configuration of one or more narrowband filters of the UE for backscattering communications.

Another aspect provides a method for wireless communication by a network entity. The method includes obtaining an indication of a filtering capability of a UE.

The method includes outputting, based at least in part on the filtering capability, a configuration that configures one or more narrowband filters of the UE for backscattering communications.

Other aspects provide: an apparatus operable, configured, or otherwise adapted to perform any one or more of the aforementioned methods and/or those described herein with reference to and as illustrated by the drawings and specification; a non-transitory, computer-readable medium comprising computer-executable instructions that, when executed by a processor of an apparatus, cause the apparatus to perform the aforementioned methods and/or those described herein with reference to and as illustrated by the drawings and specification; a computer program product embodied on a computer-readable storage medium comprising code for performing the aforementioned methods and/or those described herein with reference to and as illustrated by the drawings and specification; and/or an apparatus comprising means for performing the aforementioned methods and/or those described herein with reference to and as illustrated by the drawings and specification. By way of example, an apparatus may comprise a processing system, a device with a processing system, or processing systems cooperating over one or more networks.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 depicts an example of a wireless communications network, in accordance with the present disclosure.

FIG. 2 depicts aspects of an example base station (BS) and user equipment (UE), in accordance with the present disclosure.

FIG. 3 depicts an example disaggregated base station architecture, in accordance with the present disclosure.

FIGS. 4A, 4B, 4C, and 4D depict aspects of data structures for a wireless communications network, such as the wireless communications network of FIG. 1, in accordance with the present disclosure.

FIG. 5 is a diagram illustrating an example associated with a backscatter-based passive radio frequency identification (RFID) device, in accordance with the present disclosure.

FIG. 6 is a diagram illustrating an example associated with ambient internet of things (IoT) devices, in accordance with the present disclosure.

FIG. 7 is a diagram illustrating examples associated with use cases for ambient IoT devices, in accordance with the present disclosure.

FIG. 8 is a diagram illustrating an example associated with backscatter communications for ambient IoT devices, in accordance with the present disclosure.

FIG. 9 is a diagram illustrating examples associated with orthogonal frequency division multiplexing (OFDM) communications for ambient IoT devices, in accordance with the present disclosure.

FIG. 10 is a diagram illustrating an example associated with configuring narrowband filters for backscattering communications, in accordance with the present disclosure.

FIG. 11 is a diagram illustrating tables that include parameters associated with configuring narrowband filters for backscattering communications, in accordance with the present disclosure.

FIG. 12 is a diagram illustrating examples associated with aspects for identifying narrowband filter(s) of a UE, in accordance with the present disclosure.

FIG. 13 shows a method for wireless communications by a UE, in accordance with the present disclosure.

FIG. 14 shows a method for wireless communications by a network entity, in accordance with the present disclosure.

FIG. 15 is a diagram illustrating an example of an implementation of code and circuitry for a communications device, in accordance with the present disclosure.

FIG. 16 is a diagram illustrating an example of an implementation of code and circuitry for a communications device, in accordance with the present disclosure.

### DETAILED DESCRIPTION

Aspects of the present disclosure provide apparatuses, methods, processing systems, and computer-readable mediums for configuring narrowband filters for backscattering communications.

“Backscattering” refers to a telecommunication technique whereby a user equipment (UE) transmits information by reflecting (or “backscattering”) an incoming signal. For example, the UE may filter a backscattered signal using one or more narrowband filters and transmit the backscattered signal via an antenna. In some cases, transmissions from other UEs can interfere with the backscattered transmissions, which may prevent the backscattered transmissions from being successfully received by a receiving device.

Various aspects relate generally to wireless communication and more particularly to backscattering communications. Some aspects more specifically relate to configuring narrowband filters for backscattering communications. In some examples, a base station (BS) may configure one or more narrowband filters of a UE for backscattering communications. For example, the BS may indicate how the UE should perform the backscattering communications using the narrowband filters. For example, the BS may indicate, among other parameters, how many repeated (e.g., redundant) bits the UE should transmit.

In some aspects, the BS may determine whether to configure the UE for index modulation. “Index modulation” refers to the ability of the UE to dynamically switch between different narrowband filters during a transmission. If the BS configures the UE for index modulation, then the UE may dynamically control which narrowband filters are to be used during the backscattering communications. If the BS does not configure the UE for index modulation, then the BS may indicate which narrowband filters are to be used for backscattering. In either case, the BS may configure the UE (e.g., a multi-narrowband-filter UE) with configurable backscattering communication settings.

Index modulation may introduce flexibility to backscattering transmissions, because the narrowband filters may dynamically change during the transmission.

Moreover, the index modulation may relieve the BS of the task of indicating which narrowband filters are to be used for backscattering, which may reduce processing operations on the BS and/or may reduce overhead associated with signaling the indication of the narrowband filters to be used for backscattering. Enabling the BS to indicate which narrowband filters are to be used for backscattering may allow UEs that cannot perform index modulation, or UEs that can perform index modulation but should not, to backscatter transmissions in accordance with the configuration received from the BS.

Particular aspects of the subject matter described in this disclosure can be implemented to realize one or more of the following potential advantages. In some examples, by configuring the narrowband filters for the backscattering communications, the described techniques can be used to help mitigate interference. For example, the repeated bits may help to improve the robustness of the backscattering communications. Thus, the configuration may help to ensure that the backscattering communications are transmitted to the receiving device successfully.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

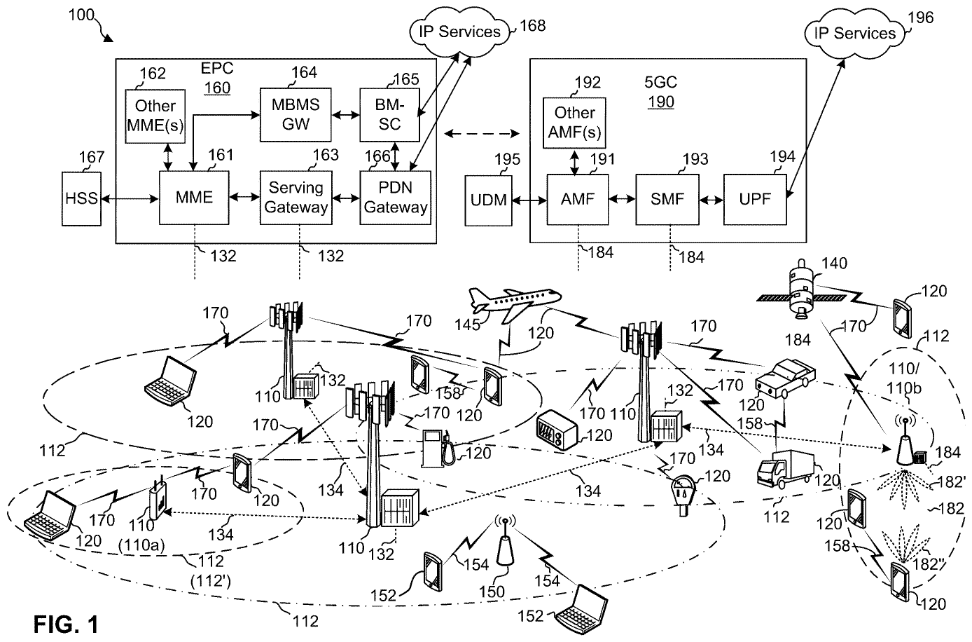

FIG. 1 depicts an example of a wireless communications network 100, in accordance with the present disclosure.

Generally, wireless communications network 100 includes various network entities (alternatively, network elements or network nodes). A network entity is generally a communications device and/or a communications function performed by a communications device (e.g., a UE, a BS, a component of a BS, a server, etc.). For example, various functions of a network as well as various devices associated with and interacting with a network may be considered network entities. Further, wireless communications network 100 includes terrestrial aspects, such as ground-based network entities (e.g., BSs 110), and non-terrestrial aspects, such as satellite 140 and aircraft 145, which may include network entities on-board (e.g., one or more BSs) capable of communicating with other network elements (e.g., terrestrial BSs) and UEs.

In the depicted example, wireless communications network 100 includes BSs 110, UEs 120, and one or more core networks, such as an Evolved Packet Core (EPC) 160 and 5G Core (5GC) 190, which interoperate to provide communications services over various communications links, including wired and wireless links.

FIG. 1 depicts various example UEs 120, which may include a cellular phone, a smart phone, a session initiation protocol (SIP) phone, a laptop, a personal digital assistant (PDA), a satellite radio, a global positioning system (GPS), a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an internet of things (IoT) device (e.g., an ambient IoT device), an always on (AON) device, an edge processing device, or another similar device. A UE 120 may also be referred to as a mobile device, a wireless device, a wireless communication device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, or a handset, among other examples.

BSs 110 may wirelessly communicate with (e.g., transmit signals to or receive signals from) UEs 120 via communications links 170. The communications links 170 between BSs 110 and UEs 120 may carry uplink (UL) (also referred to as reverse link) transmissions from a UE 120 to a BS 110 and/or downlink (DL) (also referred to as forward link) transmissions from a BS 110 to a UE 120. The communications links 170 may use multiple-input and multiple-output (MIMO) antenna technology, including spatial multiplexing, beamforming, and/or transmit diversity in various aspects.

A BS 110 may include, for example, a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point, and/or others. A BS 110 may provide communications coverage for a respective geographic coverage area 112, which may sometimes be referred to as a cell, and which may overlap in some cases (e.g., a small cell provided by a BS 110a may have a coverage area 112′ that overlaps the coverage area 112 of a macro cell). A BS 110 may, for example, provide communications coverage for a macro cell (covering a relatively large geographic area), a pico cell (covering a relatively smaller geographic area, such as a sports stadium), a femto cell (covering a relatively smaller geographic area (e.g., a home)), and/or other types of cells.

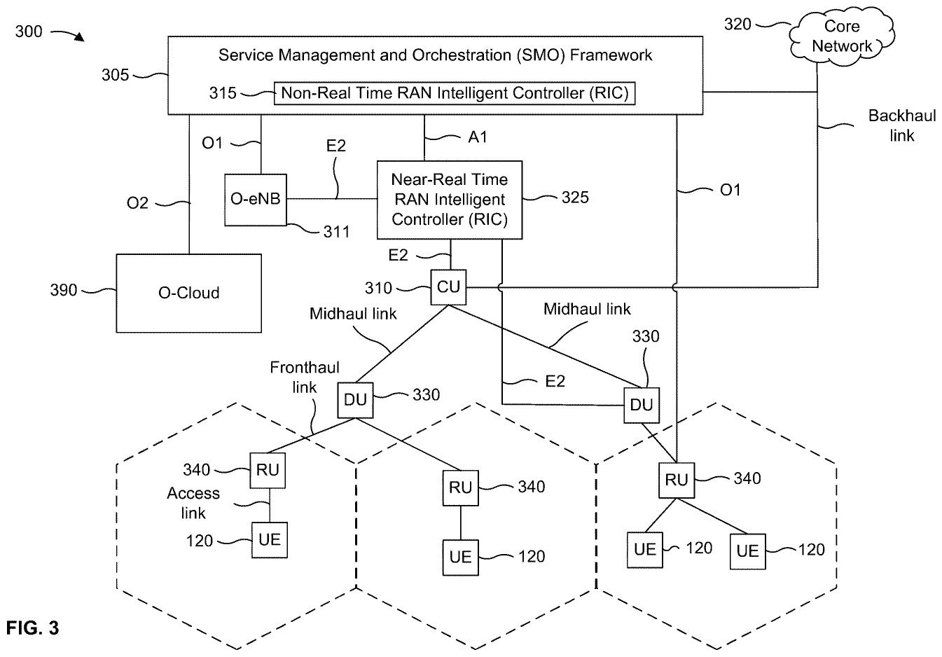

While BSs 110 are depicted in various aspects as unitary communications devices, BSs 110 may be implemented in various configurations. For example, one or more components of a base station may be disaggregated, including a central unit (CU), one or more distributed units (DUs), one or more radio units (RUs), a Near-Real Time (Near-RT) RAN Intelligent Controller (RIC), or a Non-Real Time (Non-RT) RIC, to name a few examples. In another example, various aspects of a base station may be virtualized. More generally, a BS (e.g., BS 110) may include components that are located at a single physical location or components located at various physical locations. In examples in which a BS includes components that are located at various physical locations, the various components may each perform functions such that, collectively, the various components achieve functionality that is similar to a BS that is located at a single physical location. In some aspects, a BS including components that are located at various physical locations may be referred to as having a disaggregated radio access network architecture, such as an Open RAN (O-RAN) architecture or a Virtualized RAN (VRAN) architecture. FIG. 3 depicts and describes an example disaggregated BS architecture.

Different BSs 110 within wireless communications network 100 may also be configured to support different radio access technologies, such as 3G, 4G, and/or 5G, among other examples. For example, BSs 110 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 110 configured for 5G (e.g., 5G NR or Next Generation RAN (NG-RAN)) may interface with 5GC 190 through second backhaul links 184. BSs 110 may communicate directly or indirectly (e.g., through the EPC 160 or 5GC 190) with each other over third backhaul links 134 (e.g., X2 interfaces), which may be wired or wireless.

Wireless communications network 100 may subdivide the electromagnetic spectrum into various classes, bands, channels, or other features. In some aspects, the subdivision is based on wavelength and frequency, where frequency may also be referred to as a carrier, a subcarrier, a frequency channel, a tone, or a subband. For example, 3GPP currently defines Frequency Range 1 (FR1) as including 410 MHz 7125 MHz, which is often referred to (interchangeably) as “Sub- 6 GHz”. Similarly, 3GPP currently defines Frequency Range 2 (FR2) as including 24,250 MHz-52,600 MHz, which is sometimes referred to (interchangeably) as a “millimeter wave” (“mmW” or “mmWave”). A base station configured to communicate using mm Wave or near mm Wave radio frequency bands (e.g., a mmWave base station such as BS 110b) may utilize beamforming (e.g., as shown by 182) with a UE (e.g., 120) to improve path loss and range.

The communications links 170 between BSs 110 and, for example, UEs 120, may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. In some examples, allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., base station 110b in FIG. 1) may utilize beamforming with a UE 120 to improve path loss and range, as shown at 182. For example, BS 110b and the UE 120 may each include a plurality of antennas, such as antenna elements, antenna panels, and/or antenna arrays to facilitate the beamforming. In some cases, BS 110b may transmit a beamformed signal to UE 120 in one or more transmit directions 182′. UE 120 may receive the beamformed signal from the BS 110b in one or more receive directions 182″. UE 120 may also transmit a beamformed signal to the BS 110b in one or more transmit directions 182″. BS 110b may also receive the beamformed signal from UE 120 in one or more receive directions 182′. BS 110b and UE 120 may then perform beam training to determine the best receive and transmit directions for each of BS 110b and UE 120. Notably, the transmit and receive directions for BS 110b may or may not be the same. Similarly, the transmit and receive directions for UE 120 may or may not be the same.

Wireless communications network 100 further includes a Wi-Fi access point (AP) 150 in communication with Wi-Fi stations (STAs) 152 via communications links 154 in, for example, a 2.4 GHz and/or 5 GHz unlicensed frequency spectrum.

Certain UEs 120 may communicate with each other using device-to-device (D2D) communications link 158. D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH).

EPC 160 may include various functional components, including: a Mobility Management Entity (MME) 161, other MMEs 162, a Serving Gateway 163, a Multimedia Broadcast Multicast Service (MBMS) Gateway 164, a Broadcast Multicast Service Center (BM-SC) 165, and/or a Packet Data Network (PDN) Gateway 166, such as in the depicted example. MME 161 may be in communication with a Home Subscriber Server (HSS) 167. MME 161 is a control node that processes the signaling between the UEs 120 and the EPC 160. Generally, MME 161 provides bearer and connection management.

Generally, user Internet protocol (IP) packets are transferred through Serving Gateway 163, which is connected to PDN Gateway 166. PDN Gateway 166 provides UE IP address allocation as well as other functions. PDN Gateway 166 and the BM-SC 165 are connected to IP Services 168, which may include, for example, the Internet, an intranet, an IP Multimedia Subsystem (IMS), a Packet Switched (PS) streaming service, and/or other IP services.

BM-SC 165 may provide functions for MBMS user service provisioning and delivery. BM-SC 165 may serve as an entry point for content provider MBMS transmission, may be used to authorize and initiate MBMS Bearer Services within a public land mobile network (PLMN), and/or may be used to schedule MBMS transmissions. MBMS Gateway 164 may distribute MBMS traffic to the BSs 110 belonging to a Multicast Broadcast Single Frequency Network (MBSFN) area broadcasting a particular service, and/or may be responsible for session management (start/stop) and for collecting eMBMS related charging information.

5GC 190 may include various functional components, including: an Access and Mobility Management Function (AMF) 191, other AMFs 192, a Session Management Function (SMF) 193, and a User Plane Function (UPF) 194. AMF 191 may be in communication with Unified Data Management (UDM) 195.

AMF 191 is a control node that processes signaling between UEs 120 and 5GC 190. AMF 191 provides, for example, quality of service (QoS) flow and session management.

IP packets are transferred through UPF 194, which is connected to the IP Services 196, and which provides UE IP address allocation as well as other functions for 5GC 190. IP Services 196 may include, for example, the Internet, an intranet, an IMS, a PS streaming service, and/or other IP services.

In various aspects, a network entity or network node can be implemented as an aggregated base station, a disaggregated base station, a component of a base station, an integrated access and backhaul (IAB) node, a relay node, a sidelink node, a transmission reception point (TRP), or a combination thereof, to name a few examples.

As indicated above, FIG. 1 is provided as an example. Other examples may differ from what is described with regard to FIG. 1.

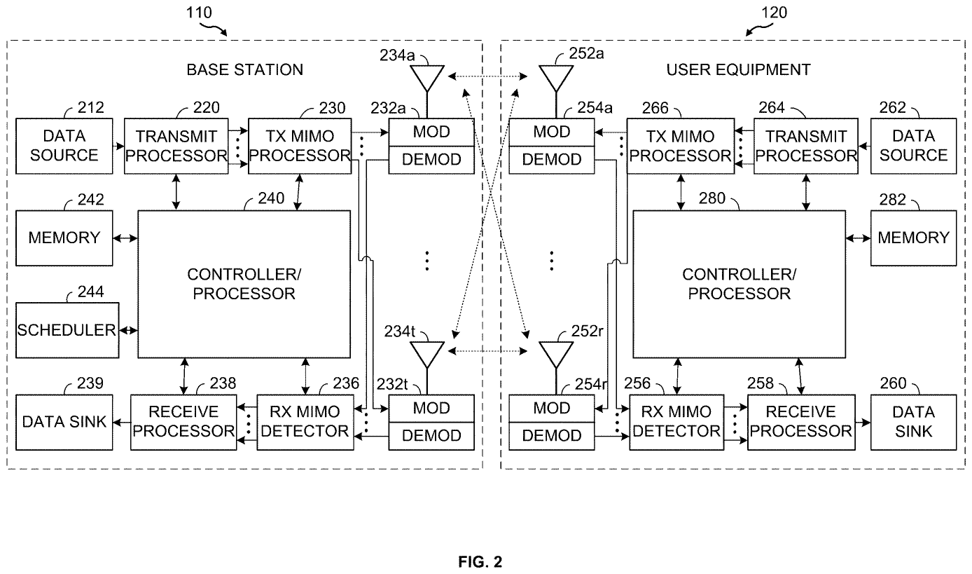

FIG. 2 depicts aspects of an example BS 110 and UE 120, in accordance with the present disclosure.

Generally, BS 110 includes various processors (e.g., 220, 230, 238, and 240), antennas 234a-t (collectively 234), transceivers 232 a-t (collectively 232), which include modulators and demodulators, and other aspects, which enable wireless transmission of data (e.g., data source 212) and wireless reception of data (e.g., data sink 239). For example, BS 110 may send and receive data between BS 110 and UE 120. BS 110 includes controller/processor 240, which may be configured to implement various functions described herein related to wireless communications.

Generally, UE 120 includes various processors (e.g., 258, 264, 266, and 280), antennas 252a-r (collectively 252), transceivers 254a-r (collectively 254), which include modulators and demodulators, and other aspects, which enable wireless transmission of data (e.g., retrieved from data source 262) and wireless reception of data (e.g., provided to data sink 260). UE 120 includes controller/processor 280, which may be configured to implement various functions described herein related to wireless communications.

For an example downlink transmission, BS 110 includes a transmit processor 220 that may receive data from a data source 212 and control information from a controller/processor 240. The control information may be for the physical broadcast channel (PBCH), the physical control format indicator channel (PCFICH), the physical hybrid automatic repeat request (HARQ) indicator channel (PHICH), the physical downlink control channel (PDCCH), the group common PDCCH (GC PDCCH), and/or other channels. The data may be for the physical downlink shared channel (PDSCH), in some examples.

Transmit processor 220 may process (e.g., encode and symbol map) the data and control information to obtain data symbols and control symbols, respectively.

Transmit processor 220 may also generate reference symbols, such as for the primary synchronization signal (PSS), the secondary synchronization signal (SSS), the PBCH demodulation reference signal (DMRS), or the channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

UE 120 includes antennas 252a-252r that may receive the downlink signals from the BS 110 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 120 to a data sink 260, and provide decoded control information to a controller/processor 280.

For an example uplink transmission, UE 120 further includes a transmit processor 264 that may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for single-carrier frequency division multiplexing (SC-FDM)), and transmitted to BS 110.

At BS 110, the uplink signals from UE 120 may be received by antennas 234a-234t, processed by the demodulators in transceivers 232a-232t, detected by a MIMO detector 236 if applicable, and further processed by a receive processor 238 to obtain decoded data and control information sent by UE 120. Receive processor 238 may provide the decoded data to a data sink 239 and the decoded control information to the controller/processor 240. Memories 242 and 282 may store data and program codes (e.g., processor-executable instructions, computer-executable instructions) for BS 110 and UE 120, respectively. Scheduler 244 may schedule UEs for data transmission on the downlink and/or uplink.

In various aspects, BS 110 may be described as transmitting and receiving various types of data associated with the methods described herein. In these contexts, “transmitting” may refer to various mechanisms of outputting data, such as outputting data from data source 212, scheduler 244, memory 242, transmit processor 220, controller/processor 240, TX MIMO processor 230, transceivers 232a-t, antenna 234a-t, and/or other aspects described herein. Similarly, “receiving” may refer to various mechanisms of obtaining data, such as obtaining data from antennas 234a-t, transceivers 232a-t, receive (RX) MIMO detector 236, controller/processor 240, receive processor 238, scheduler 244, memory 242, a network interface, and/or other aspects described herein.

In various aspects, UE 120 may likewise be described as transmitting and receiving various types of data associated with the methods described herein. In these contexts, “transmitting” may refer to various mechanisms of outputting data, such as outputting data from data source 262, memory 282, transmit processor 264, controller/processor 280, TX MIMO processor 266, transceivers 254a-t, antenna 252a-t, and/or other aspects described herein. Similarly, “receiving” may refer to various mechanisms of obtaining data, such as obtaining data from antennas 252a-t, transceivers 254a-t, RX MIMO detector 256, controller/processor 280, receive processor 258, memory 282, and/or other aspects described herein.

In some aspects, a processor may be configured to perform various operations, such as those associated with the methods described herein, and transmit (output) data to or receive (obtain) data from another interface that is configured to transmit or receive, respectively, the data.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR BS, a 5G NB, an AP, a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

FIG. 3 depicts an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 120 via one or more radio frequency (RF) access links. In some implementations, the UE 120 may be simultaneously served by multiple RUs 340.

Each of the units (e.g., the CUS 310, the DUs 330, the RUs 340, as well as the Near-RT RICs 325, the Non-RT RICs 315 and the SMO Framework 305) may include one or more interfaces or be coupled to one or more interfaces configured to receive or transmit signals, data, or information (collectively, signals) via a wired or wireless transmission medium. Each of the units, or an associated processor or controller providing instructions to the communications interfaces of the units, can be configured to communicate with one or more of the other units via the transmission medium. For example, the units can include a wired interface configured to receive or transmit signals over a wired transmission medium to one or more of the other units.

Additionally or alternatively, the units can include a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like.

Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 340 can be implemented to handle over-the-air (OTA) communications with one or more UEs 120. In some implementations, real-time and non-real-time aspects of control and user plane communications with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, artificial intelligence/machine learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

As indicated above, FIG. 3 is provided as an example. Other examples may differ from what is described with regard to FIG. 3.

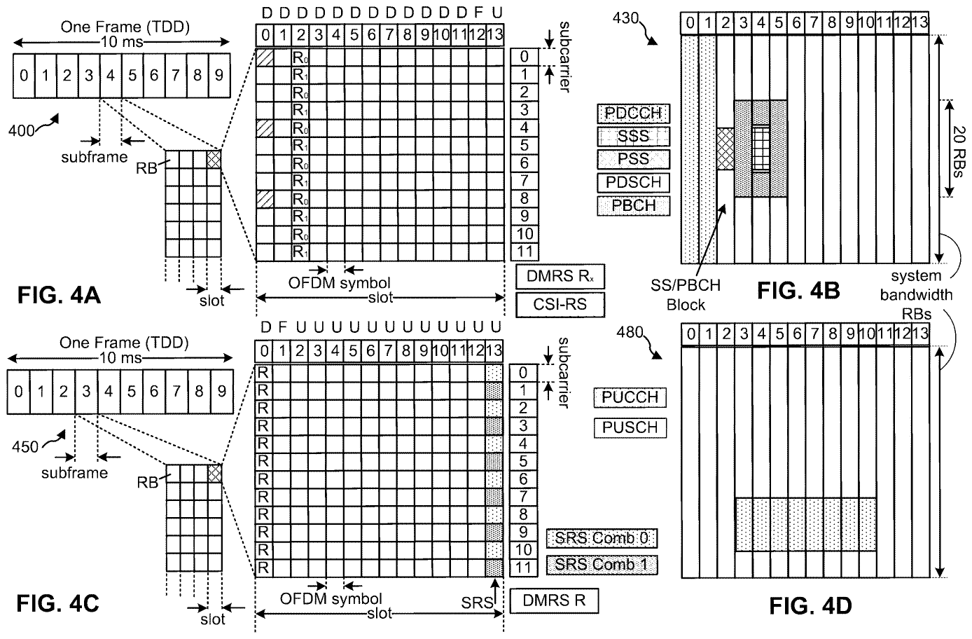

FIGS. 4A, 4B, 4C, and 4D depict aspects of data structures for a wireless communications network, such as wireless communications network 100 of FIG. 1, in accordance with the present disclosure. FIG. 4A is a diagram 400 illustrating an example of a first subframe within a 5G (e.g., 5G NR) frame structure, FIG. 4B is a diagram 430 illustrating an example of DL channels within a 5G subframe, FIG. 4° C. is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. Each subcarrier may be modulated with data. Modulation symbols may be sent in the frequency domain with OFDM and/or in the time domain with SC-FDM.

A wireless communications frame structure may be frequency division duplex (FDD), in which, for a particular set of subcarriers, subframes within the set of subcarriers are dedicated for either DL or UL. Wireless communications frame structures may also be time division duplex (TDD), in which, for a particular set of subcarriers, subframes within the set of subcarriers are dedicated for both DL and UL.

In FIGS. 4A and 4C, the wireless communications frame structure is TDD where D is DL, U is UL, and F is flexible for use between DL/UL. UEs may be configured with a slot format through a received slot format indicator (SFI) (dynamically through DL control information (DCI), or semi-statically/statically through RRC signaling). In the depicted examples, a 10 ms frame is divided into 10 equally sized 1 ms subframes. Each subframe may include one or more time slots. In some examples, each slot may include 7 or 14 symbols, depending on the slot format.

Subframes may also include mini-slots, which generally have fewer symbols than an entire slot. Other wireless communications technologies may have a different frame structure and/or different channels.

In certain aspects, the number of slots within a subframe is based on a slot configuration and a numerology. For example, for slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2^{μ} slots/subframe. The subcarrier spacing and symbol length/duration are a function of the numerology. The subcarrier spacing may be equal to 2^{μ}×15 kHz, where μ is the numerology index, which may be selected from values 0 to 5. Accordingly, the numerology μ=0 has a subcarrier spacing of 15 kHz and the numerology μ=5 has a subcarrier spacing of 480 kHz. Other numerologies and subcarrier spacings may be used. The symbol length/duration is inversely related to the subcarrier spacing. FIGS. 4A, 4B, 4C, and 4D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as physical RBs (PRBs)) that extends, for example, 12 consecutive subcarriers. The resource grid is divided into multiple resource elements (REs). The number of bits carried by each RE depends on the modulation scheme.

As illustrated in FIG. 4A, some of the REs carry reference (pilot) signals (RSS) for a UE (e.g., UE 120). The RSs may include demodulation RSs (DMRSs) and/or channel state information reference signals (CSI-RSs) for channel estimation at the UE. The RSs may also include beam measurement RSs (BRSs), beam refinement RSs (BRRSs), and/or phase tracking RSs (PT-RSs).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., UE 120) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRSs. The PBCH, which carries a master information block (MIB), may be logically grouped with the PSS and SSS to form a synchronization signal (SS)/PBCH block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRSs (indicated as R for one particular configuration, but other DMRS configurations are possible) for channel estimation at the base station. The UE may transmit DMRSs for the PUCCH and DMRSs for the PUSCH. The PUSCH DMRSs may be transmitted, for example, in the first one or two symbols of the PUSCH. The PUCCH DMRSs may be transmitted in different configurations depending on whether short or long PUCCHs are transmitted and depending on the particular PUCCH format used. UE 120 may transmit sounding reference signals (SRSs). The SRSs may be transmitted, for example, in the last symbol of a subframe. The SRSs may have a comb structure, and a UE may transmit SRSs on one of the combs. The SRSs may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

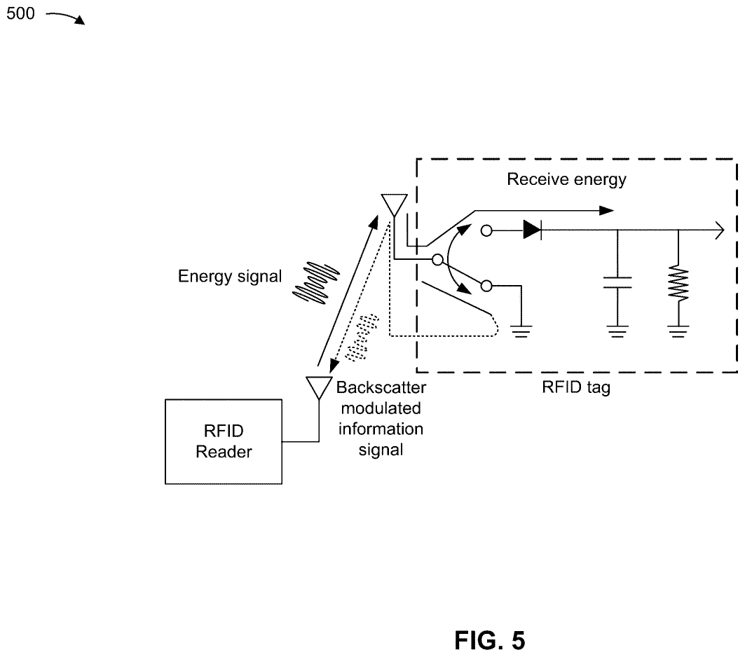

FIG. 5 is a diagram illustrating an example 500 associated with a backscatter-based passive radio frequency identification (RFID) device, in accordance with the present disclosure.

RFID has applications in inventory and asset management (both inside and outside the warehouse), IoT, sustainable sensor networks in factories and/or agriculture, smart homes, or the like. RFID devices include small transponders (also referred to as tags) that emit information-bearing signals upon receiving a signal. RFID devices may be operated without battery with low operating expense, low maintenance cost, and a long life-cycle.

A passive RFID device may harvest energy over the air. For example, a passive RFID device may harvest energy from an energy signal received from an RFID reader. The harvested energy may power the transmission and/or reception circuitry, where the transmitted signal is typically backscatter modulated.

A semi-passive RFID device may have a battery or capacitor to store energy but may be unable to generate a signal autonomously (e.g., a semi-passive RFID device may use backscattering technology to communicate). An active RFID device may be equipped with a battery and may generate a signal autonomously. Semi-passive or active RFID devices may have higher associated costs than passive RFID devices.

As indicated above, FIG. 5 is provided as an example. Other examples may differ from what is described with regard to FIG. 5.

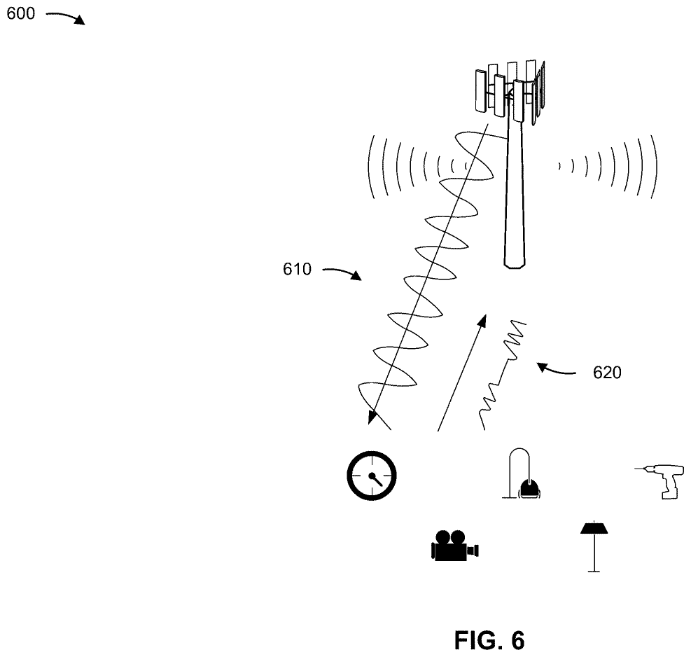

FIG. 6 is a diagram illustrating an example 600 associated with ambient IoT devices, in accordance with the present disclosure.

As 5G continues to expand into industrial verticals other than enhanced mobile broadband (eMBB) (e.g., altra-reliable low latency communications (URLLC), machine type communication (MTC), or the like), telecommunications technology may be expanded to support ambient IoT for use cases including MTC, narrowband IoT (NB-IoT), reduced capability for MTC, or the like. However, current 5G technology may be unable to efficiently support ambient IoT devices (e.g., a pervasive RFID-type sensor) in many future use cases, such as asset management, logistics, warehousing, manufacturing, or the like.

As shown, telecommunication standards may enable management of ambient IoT devices. For example, as shown by reference number 610, a network entity (e.g., BS 110) may read and/or write information stored on ambient IoT devices and/or provide energy to the ambient IoT devices As shown by reference number 620, the network entity may receive information-bearing signals reflected by the ambient IoT devices, read the reflected information-bearing signals to decode the information transmitted by the ambient IoT devices, or the like.

As indicated above, FIG. 6 is provided as an example. Other examples may differ from what is described with regard to FIG. 6.

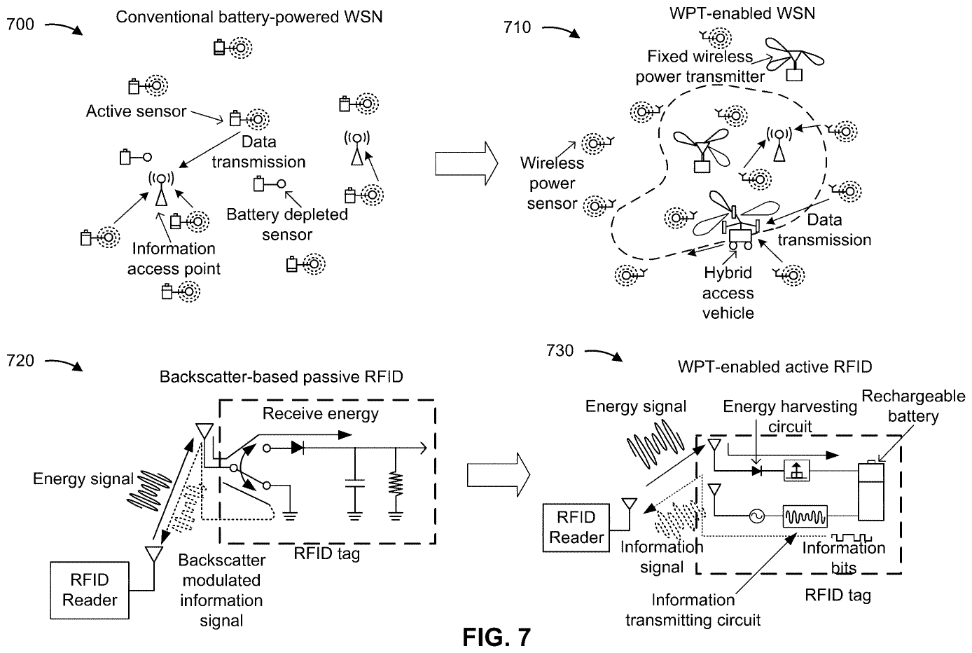

FIG. 7 is a diagram illustrating examples 700, 710, 720, and 730 associated with use cases for ambient IoT devices, in accordance with the present disclosure.

Example 700 is associated with a conventional battery-powered wireless sensor network (WSN). In example 700, sensors with batteries transmit data to one or more network nodes. Sensors with depleted batteries may be unable to transmit data to the network node(s).

Example 710 is associated with a wireless power transfer (WPT)-enabled WSN. Various WPT-enabled devices may harvest energy from hybrid energy sources (e.g., the network, solar, wind, or the like). WPT-enabled WSNs may thereby avoid manual battery replacement and may offer longer device lifetimes.

Example 720 is associated with backscatter-based passive RFID, as illustrated in, and described in connection with, FIG. 5. Example 730 is associated with WPT-enabled active RFID. WPT-enabled active RFID scenarios may offer bigger ranges than passive RFID scenarios. In WPT-enabled active RFID scenarios, energy may be gathered over longer durations than the duration of information transfer.

As indicated above, FIG. 7 is provided as an example. Other examples may differ from what is described with regard to FIG. 7.

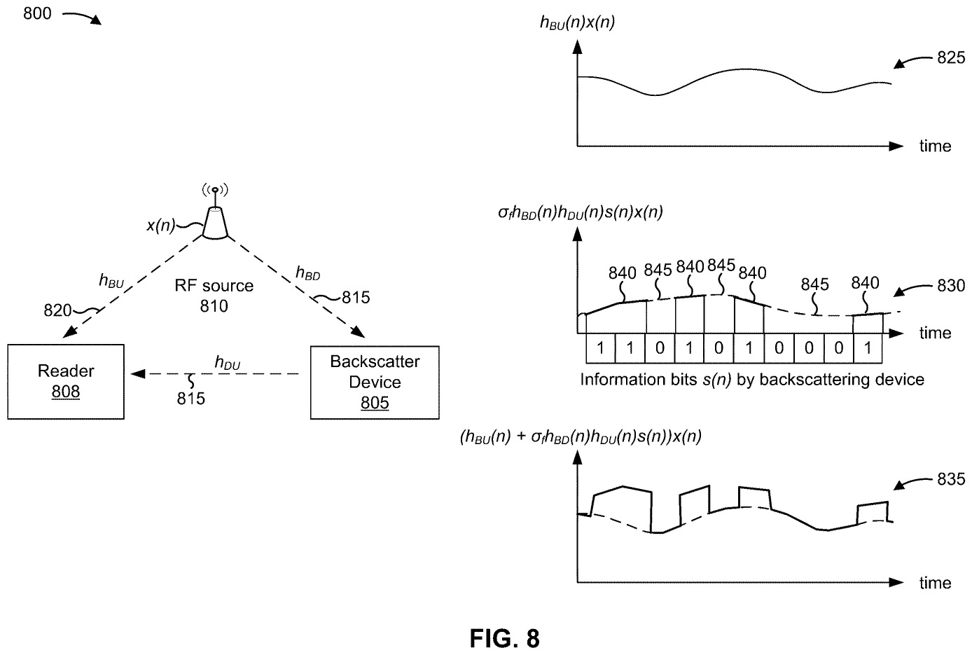

FIG. 8 is a diagram illustrating an example 800 associated with backscatter communications for ambient IoT devices, in accordance with the present disclosure.

Some wireless communication devices may be considered IoT devices. IoT technology may include ambient IoT (e.g., passive IoT, such as NR passive IoT for 5G Advanced, semi-passive IoT, active IoT, or ultra-light IoT, among other examples). In passive IoT, a terminal (e.g., an RFID device, a tag, or a similar device) may not include a battery, and the terminal may accumulate energy from radio signaling. Additionally, the terminal may accumulate solar energy to supplement accumulated energy from radio signaling. In passive IoT, a communication distance may be up to approximately 30 meters to facilitate feasible network coverage over a large area (e.g., 5000 square meters), such as in a warehouse. Moreover, the power consumption of a passive IoT terminal (e.g., a UE) may be less than 0.1 milliwatts (mW), to support operation without a battery, and the terminal may be relatively inexpensive, to facilitate cost-sensitive uses. A positioning accuracy of a passive IoT terminal may be approximately 3-5 meters in the horizontal and the vertical directions.

Ambient IoT may be useful in connection with industrial sensors, for which battery replacement may be prohibitively difficult or undesirable (e.g., for safety monitoring or fault detection in smart factories, infrastructures, or environments). Additionally, features of ambient IoT devices, such as low cost, small size, maintenance-free, durable, long lifespan, or the like, may facilitate smart logistics/warehousing (e.g., in connection with automated asset management by replacing RFID tags). Furthermore, ambient IoT may be useful in connection with smart home networks for household item management, wearable devices (e.g., wearable devices for medical monitoring for which patients do not need to replace batteries), and/or environment monitoring. To achieve further cost reduction and zero-power communication, 5G+/6G wireless networks may utilize ambient IoT devices.

As shown in FIG. 8, a backscatter device 805 (e.g., a tag, a sensor, or the like), which may be one example of a passive IoT device, may employ a simplified hardware design (e.g., including a power splitter, an energy harvester, and a microcontroller) that does not include a battery, such that the backscatter device 805 relies on energy harvesting for power, and that does not include a radio wave generation circuit, such that the backscatter device 805 is capable of transmitting information only by reflecting a radio wave. More particularly, the backscatter device 805 communicates with a reader 808 (e.g., a UE 120, a BS 110, or another network device) by modulating a reflecting radio signal from an RF source 810 (e.g., a BS 110, a UE 120, or another network device). In some examples, the RF source 810 and the reader 808 may be the same device and/or may be co-located. For example, in some cases, the reader 808 and the RF source 810 may be associated with the same BS 110.

To facilitate communication of the backscatter device 805, the RF source 810 may transmit an energy harvesting wave to the backscatter device 805. The energy harvesting wave may be transmitted for a sufficient duration in order to enable a communication phase for a target range between the reader 808 and the backscatter device 805. Additionally, or alternatively, in some cases, a range between the RF source 810 and the backscatter device 805 may be limited by a minimum received power for triggering energy harvesting at the backscatter device 805, such as −20 decibel milliwatts (dBm).

Once energy is sufficiently accumulated at the backscatter device 805, the backscatter device 805 may begin to reflect the radio wave that is radiated onto the backscatter device 805 via a backscatter link 815. For example, the RF source 810 may initiate a communication session (sometimes referred to as a query-response communication) with a query, which may be a modulating envelope of a continuous wave (CW). The backscatter device 805 may respond by backscattering the CW. Thus, the backscatter device 805 may support envelope detection. The communication session may include multiple rounds, such as for purposes of contention resolution when multiple backscatter devices respond to a query. A channel between the RF source 810 and the backscatter device 805 of the backscatter link 815 may be associated with a first backscatter link channel response value (sometimes referred to as a first backscatter link channel coefficient or a first backscatter link gain value), h_{BD}. As described below, the backscatter device 805 may have reflection-on periods and reflection-off periods that follow a pattern that is based at least in part on the transmission of information bits by the backscatter device 805. The reader 808 may detect the reflection pattern of the backscatter device 805 and obtain the backscatter communication information via the backscatter link 815. A channel between the reader 808 and the backscatter device 805 of the backscatter link 815 may be associated with a second backscatter link channel response value (sometimes referred to as a second backscatter link channel coefficient or a second backscatter link channel gain value), hDU. In addition, the RF source 810 and the reader 808 may communicate (e.g., reference signals and/or data signals) via a direct link 820. A channel between the RF source 810 and the reader 808 of the direct link 820 may be associated with a direct link channel response value (sometimes referred to as a direct link channel coefficient or a direct link channel gain value), hBU.

The backscatter device 805 may use an information modulation scheme, such as amplitude shift keying (ASK) modulation or on-off keying (OOK) modulation. For ASK or OOK modulation, the backscatter device 805 may switch on reflection when transmitting an information bit “1” and switch off reflection when transmitting an information bit “0.” In backscatter communication, the RF source 810 may transmit a particular radio wave (e.g., a reference signal or a data signal, such as a PDSCH), which may be denoted as x(n). The reader 808 may receive this radio wave, x(n), directly from the RF source 810 via the direct link 820, as well as from the backscatter device 805 modulating and reflecting the radio wave to the reader 808 via the backscatter link 815. The signal received at the reader 808 via the direct link 820, denoted as h_{BU}(n)x(n) and indicated by reference number 825, is the product of the radio wave transmitted by the RF source 810, x(n), multiplied by the direct link channel response value, h_{BU}, plus any signal noise. The information bits signal of the backscatter device 805 may be denoted as s(n) where s(n)∈{0,1}. Accordingly, the signal received at the reader 808 via the backscatter link 815, denoted as σ_{f}h_{BD}(n)h_{DU}(n)s(n)x(n) and indicated by reference number 830, is the product of the signal transmitted by the RF source 810, x(n), multiplied by the first backscatter link channel response value, h_{BD}, the second backscatter link channel response value, h_{DU}, the information bits signal from the backscatter device 805, s(n), and a reflection coefficient associated with the backscatter device 805, σ_{f}, plus any noise.

Thus, the resulting signal received at the reader 808, which is the superposition of the signal received via the direct link 820 and the signal received via the backscatter link 815, may be denoted as y(n) where y(n)=(h_{BU}(n)+σ_{f}h_{BD}(n)h_{DU}(n)s(n))x(n)+noise. This signal, y(n), is shown by reference number 835. As shown, when s(n)=0 (indicated by reference number 840 in the plot shown at reference number 830), the backscatter device 805 may switch off reflection, such that the signal component σ_{f}h_{BD}(n)h_{DU}(n)s(n) equals zero, and thus the reader 808 receives only the direct link 820 signal (e.g., y(n)=h_{BU}(n)x(n)+noise). When s(n)=1 (indicated by reference number 845 in the plot shown at reference number 830), the backscatter device 805 may switch on reflection, such that signal component σ_{f}h_{BD}(n)h_{DU}(n)s(n) equals σ_{f}h_{BD}(n)h_{DU}(n), and thus the reader 808 receives a superposition of both the direct link 820 signal and the backscatter link 815 signal (e.g., y(n)=(h_{BU}(n)+σ_{f}h_{BD}(n)h_{DU}(n)x(n)+noise). To receive the information bits transmitted by the backscatter device 805, the reader 808 may first decode x(n) based at least in part on the direct link channel response value of h_{BU}(n) by treating the backscatter link 815 signal as interference. The reader 808 may then detect the existence of the signal component σ_{f}h_{BD}(n)h_{DU}(n)x(n) by subtracting h_{BU}(n)x(n) from y(n). In some cases, the backscatter device 805 may not maintain a state from communication session to communication session except of what is stored in the backscatter device 805 memory, such as an EPC associated with backscatter device 805 or similar information.

As indicated above, FIG. 8 is provided as an example. Other examples may differ from what is described with regard to FIG. 8.

Ambient-IoT-style backscattering differs from traditional-RFID-style in at least three respects. First, ambient-IoT-style backscattering may use existing RF signals. As a result, ambient IoT devices may operate without deployment of a special-purpose power infrastructure—such as an RFID reader—to transmit a high-power (e.g., 1 W) signal to nearby devices. Thus, ambient-IoT-style backscattering may avoid installation and maintenance costs that could, if unavoidable, make such a system impractical (e.g., in outdoor environments, environments that span large areas, or the like).

Second, and relatedly, ambient-IoT-style backscattering may have a small environmental footprint because ambient IoT devices may avoid consuming additional energy beyond that which is already being transmitted over the air. Third, ambient ambient-IoT-style backscattering may enable D2D communication. By contrast, traditional RFID systems may be not enable D2D communication because, in traditional RFID systems, tags communicate exclusively with an RFID reader and may be unable to detect transmissions from other, nearby tags.

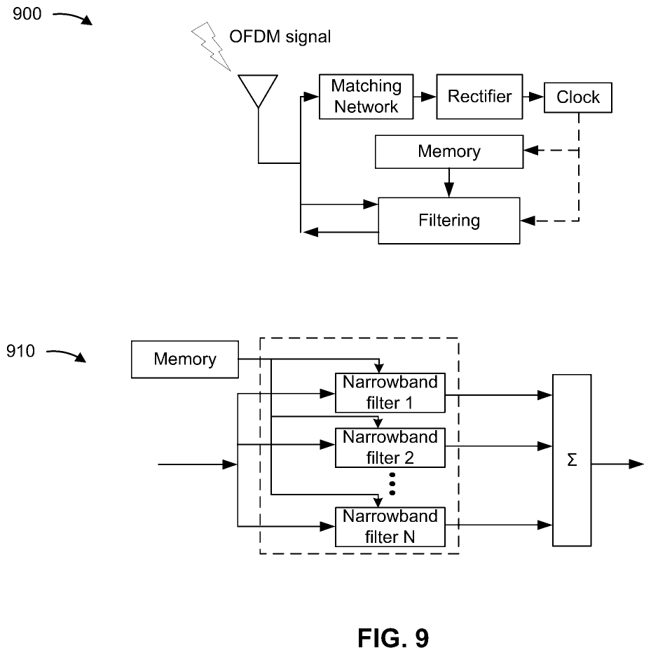

FIG. 9 is a diagram illustrating examples 900 and 910 associated with OFDM communications for ambient IoT devices, in accordance with the present disclosure.

OFDM is a common modulation scheme in many modern communication systems. As shown in example 900, an ambient IoT device receives an OFDM signal. The ambient IoT device may transfer power from the OFDM signal from the antenna to the rectifier via the matching network. The ambient IoT device may obtain power from the rectifier, filter the OFDM signal, and transmit a reflected signal.

As shown in example 910, the filtering may involve providing data to a plurality of narrowband filters that operate within respective frequency ranges. For example, each narrowband filter may filter one or more subcarrier frequencies. The narrowband filters may pass or nullify respective clusters, which may be summed and transmitted via the antenna.

As indicated above, FIG. 9 is provided as an example. Other examples may differ from what is described with regard to FIG. 9.

Some UEs (e.g., ambient IoT devices) may perform subcarrier-wise backscattering communications (e.g., over OFDM). In some cases, reflected transmissions from multiple ambient IoT devices may collide with each other. In some cases, transmissions from other devices (e.g., legacy devices) may interfere with reflected transmissions from an ambient IoT device. Collisions and interference may cause the ambient IoT device transmissions to fail (e.g., the transmissions may not be successfully received or processed by a receiving device).

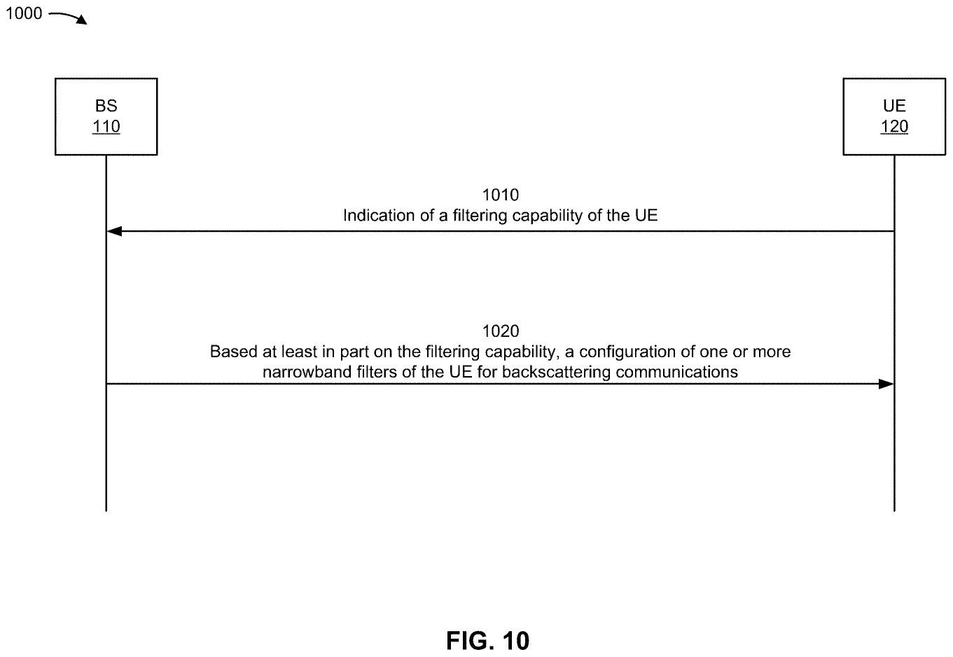

FIG. 10 is a diagram illustrating an example 1000 associated with configuring narrowband filters for backscattering communications, in accordance with the present disclosure. As shown in FIG. 10, example 1000 includes communication between a BS 110 and a UE 120 (e.g., an ambient IoT device). In some aspects, BS 110 and UE 120 may be included in a wireless network, such as wireless communications network 100. BS 110 and UE 120 may communicate via a wireless access link, which may include an uplink and a downlink.

As shown by reference number 1010, the UE 120 may transmit, and the BS 110 may obtain, an indication of a filtering capability of the UE 120. The filtering capability may include information relating to the ability (or inability) of the UE 120 to perform one or more filtering functions or filter operations. For example, the filtering capability may indicate a quantity of filters that the UE 120 has, whether the UE 120 is capable of index modulation, whether the bandwidths of the filters are tunable, or the like. Different UEs (e.g., different ambient IoT devices) may have different filtering

As shown by reference number 1020, the BS 110 may output, and the UE 120 may receive, based at least in part on the filtering capability, a configuration of one or more narrowband filters of the UE 120 for backscattering communications. In some examples, if the UE 120 has no filter or one filter, then the BS 110 may refrain from scheduling subcarrier-wise backscattering communications on the UE 120. If the UE 120 has a plurality of filters (e.g., a filter band of passive notch filters), then the BS 110 may schedule subcarrier-wise backscattering communications on the UE 120.

The configuration of the one or more narrowband filters of the UE 120 may enable the BS 110 to schedule the backscattering communications. For example, the BS 110 may configure the UE 120 such that backscattering communications (e.g., reflected transmissions) from different ambient IoT devices do not collide with each other and/or such that interference from legacy device communications is reduced. For example, the BS 110 may configure a subset of OFDM subcarriers for the backscattering communications. The configuration may enable the BS 110 to indicate how the UE 120 is to perform the backscattering communication, which may ultimately improve the success rate of the ambient IoT device transmissions.

In some examples, the UE 120 may transmit, in accordance with the configuration, the backscattering communications via the one or more narrowband filters. For example, the UE 120 may transmit the backscattering communications according to information (e.g., parameters) specified by the configuration. Examples of information that can be specified by the configuration are provided below.

As indicated above, FIG. 10 is provided as an example. Other examples may differ from what is described with respect to FIG. 10.

In some aspects, the configuration may be for the one or more narrowband filters to perform the backscattering communications using index modulation. For example, the BS 110 may indicate, in the configuration, whether index modulation is to be used by the UE 120 to backscatter the communications. Index modulation may enable the UE 120 to dynamically switch between different sets or subsets of narrowband filters during the backscattering communications. For example, index modulation may enable the UE 120 to switch from backscattering via cluster 1 and cluster 2 to backscattering via cluster 2 and cluster 3 during a data packet transmission. Using index modulation to perform the backscattering communications may introduce additional flexibility to the scheduling of the backscattering communications.

In further aspects, the configuration may be for the one or more narrowband filters to perform the backscattering communications based at least in part on an energy status of the UE 120. The energy status may be an amount of power of the UE 120. The UE 120 may indicate the energy status periodically or in response to an event (e.g., in response to a trigger received from the BS 110, in response to the energy satisfying a threshold, or the like). In some examples, the BS 110 may refrain from configuring the UE 120 for index modulation if the energy status is low and may configure the UE 120 for index modulation if the energy status is high (e.g., not low). Index modulation may cause the UE 120 to consume a significant amount of power, and the energy status of the UE 120 may enable the BS 110 to configure the UE 120 to avoid losing excess power due to index modulation.

The BS 110 may indicate (e.g., in the configuration) the type of information that is to be indicated by the index modulation. In some examples, the configuration may be for the one or more narrowband filters to perform a parity check (e.g., a cyclic redundancy check (CRC)) using the index modulation, which may enable error detection. In some examples, the configuration may be for the one or more narrowband filters to perform data (e.g., information) transmission using the index modulation, which may enable the UE 120 to backscatter communications to the BS 110 and/or another receiver. The configuration may be for the one or more narrowband filters to perform, using the index modulation, the parity check and/or the data transmission.

If the configuration is for the one or more narrowband filters to perform data (e.g., information) transmission using the index modulation, then the configuration may include an indication of a quantity of bits that are to be transmitted using the index modulation. For instance, the configuration may configure the UE 120 to use index modulation to indicate a single or original data bit or one or more repeated bits (e.g., bits that are to be repeated for improved transmission reliability). Including the indication of the quantity of bits in the configuration may enable the UE 120 to determine a quantity of narrowband filters to use for the index modulation.

In some examples, the indication of the quantity of the bits includes an indication of a quantity of at least one narrowband filter that is to transmit at least one of the bits. For example, the configuration may indicate the quantity of narrowband filters that are to be used for index modulation. The indication of the quantity of narrowband filter(s) may be considered a non-explicit (or implicit) indication of the quantity of the bits because the indication may indicate the quantity of bits via a conversion from the quantity of narrowband filter(s) to the quantity of the bits. Including an indication of a quantity of at least one narrowband filter in the indication of the quantity of the bits may enable the UE 120 to avoid using processing and/or memory resources to convert from a quantity of bits to a quantity of narrowband filters.

In some examples, the indication of the quantity of the bits is an explicit indication of the quantity of the bits. The explicit indication may directly indicate the quantity of bits that are to be transmitted using index modulation. For example, the explicit indication of the quantity of the bits may identify the quantity of bits without requiring a conversion to (or calculation of) the quantity of bits from another parameter.

If the configuration is for the one or more narrowband filters to perform data (e.g., information) transmission using the index modulation, then the configuration may include an indication of a duration of the data transmission via the index modulation. In some examples, the indication of the duration of the data transmission may include an explicit indication of the duration of the data transmission. For example, the indication may directly indicate the absolute duration of the data transmission. The explicit indication of the duration may identify the duration without requiring a conversion to (or calculation of) the duration from another parameter. The indication of the duration of the data transmission may inform the UE 120 of how long to transmit the data.

In some examples, the indication of the duration of the data transmission may be an indication of a ratio of the duration (D_{T}) of the data transmission and a reference duration (D_{R}). For example, the ratio may be D_{T}:D_{R}. The indication of the ratio may be considered a non-explicit (or implicit) indication of the duration because the indication may indicate the duration via a conversion from the ratio to the duration. The reference duration may be a predefined (e.g., RRC-configured) duration or a duration of the cluster-, block-, and/or narrowband-based backscattering. The predefined duration may be common for all UEs, which may result in lower overhead. The duration of the cluster-, block-, and/or narrowband-based backscattering may be specific to individual UEs, which may improve configurability.

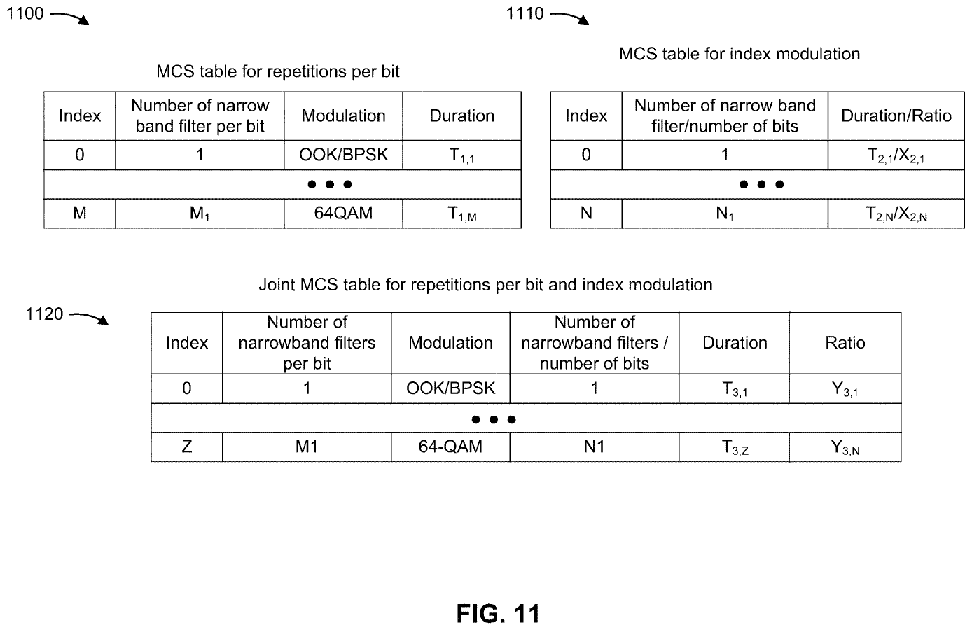

FIG. 11 is a diagram illustrating tables 1100, 1110, and 1120 that include parameters associated with configuring narrowband filters for backscattering communications, in accordance with the present disclosure. Tables 1100, 1110, and/or 1120 may contain information relating to modulation and coding schemes, and may enable the UE 120 to transmit one or more indications relating to index modulation and/or repetitions per bit or quantity of narrowband filters per bit.

Table 1100 includes parameters associated with repeated bits (e.g., index, quantity of narrowband filters per bit, modulation scheme, duration, or the like). For example, using table 1100, the BS 110 may schedule subcarrier-wise backscatter communications at least in part by indicating the quantity of repetitions per bit. The quantity of repetitions per bit may indicate the quantity of narrowband filters that are to be used to backscatter identical information (e.g., the quantity of narrowband filters per bit).

Table 1110 includes parameters associated with index modulation (e.g., index, quantity of narrowband filters or number of bits, duration or ratio, or the like). Table 1120 includes one or more parameters associated with repeated bits (e.g., index, quantity of narrowband filters per bit, modulation scheme, duration, or the like) and one or more parameters associated with index modulation (e.g., index, quantity of narrowband filters or number of bits, duration, ratio, or the like).

In some examples, the configuration of the narrowband filter(s) for backscattering communications may be based at least in part on table 1100 and table 1110. For example, the repetitions per bit or number of narrowband filters per bit and index modulation may be respectively (e.g., separately) configured using tables 1100 and 1110. Basing the configuration at least in part on table 1100 and table 1110 may reduce overhead. For example, in situations where index modulation is not to be used, an index from table 1100 (e.g., and not an index from table 1110) may be transmitted, which may reduce the quantity of bits involved in index signaling.

In some examples, the configuration may be based at least in part on table 1120. Table 1120 may include any suitable combination of parameters that is configurable using tables 1100 and 1110. Basing the configuration at least in part on table 1120 may reduce overhead. For example, in situations where index modulation is to be used, one index from table 1120 may be transmitted, which may reduce the quantity of bits involved in index signaling.

As indicated above, FIG. 11 is provided as an example. Other examples may differ from what is described with respect to FIG. 11.

In some aspects, index modulation may not be configured. For example, the BS 110 may determine not to configure the UE 120 for index modulation (e.g., based on the energy status of the UE 120). Additionally, or alternatively, the UE 120 may not support index modulation (e.g., the UE 120 may not be capable of tuning narrowband filters dynamically). In cases where index modulation is not to be used by UE 120, the BS 110 may indicate which narrowband filter(s) are to be used for backscattering and the repetitions per bit.

In some examples where index modulation is not configured, the configuration may be based at least in part on an identification of narrowband filter(s) of the UE 120. For example, when index modulation is not configured, the UE 120 may use a fixed set or subset of narrowband filters for the backscattering communications. For example, without index modulation, the UE 120 may use cluster 1 and cluster 2 for the duration of a data packet transmission. Basing the configuration at least in part on the identification of the narrowband filter(s) may enable the BS 110 to indicate, to the UE 120, which narrowband filter is to be used for the backscattering communications.

Several aspects are provided herein for identifying the narrowband filter(s). In a first aspect, the identification of the narrowband filter(s) may be based at least in part on a rule for the identification of the one or more narrowband filters. For example, the rule may indicate how to select the active narrowband filter(s) (e.g., the narrowband filter(s) that will be used to backscatter information). For example, the quantity of active narrowband filters may be predefined (e.g., RRC-configured), and the rule may specify which active narrowband filter(s) to activate. For example, the rule may indicate that UE 120 should select the narrowband filter with the lowest center frequency of the narrowband filters, with the middle center frequency of the narrowband filters, with the highest center frequency of the narrowband filters, or the like. The rule for the identification of the narrowband filter(s) may be predefined and/or may apply to multiple UEs and, thus, may reduce signaling overhead.

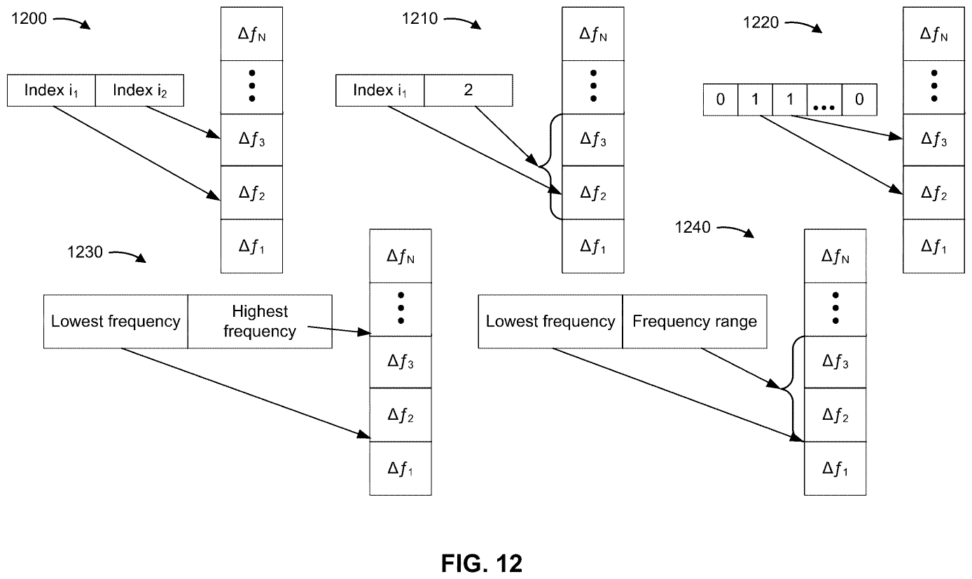

FIG. 12 is a diagram illustrating examples 1200, 1210, 1220, 1230, and 1240 associated with second and third aspects for identifying the narrowband filter(s) of UE 120, in accordance with the present disclosure. Examples 1200, 1210, and 1220 may relate to the second aspect, and examples 1230 and 1240 may relate to the third aspect.

With reference to the second aspect, in examples 1200, 1210, and 1220, the configuration includes the identification of the narrowband filter(s). For example, the BS 110 may dynamically indicate (e.g., in the configuration) which narrowband filter(s) are to be used for the backscattering communications. Thus, including the identification of the narrowband filter(s) in the configuration may enable the configuration to be UE-specific.

In examples 1200 and 1210, the identification of the narrowband filter(s) includes an indication of at least one index of at least one of the narrowband filter(s).

For example, the BS 110 may indicate the index(es) of narrowband filter(s) to the UE 120. Identifying at least one index of the narrowband filter(s) may reduce signaling overhead and/or enable signaling for consecutive and/or non-consecutive narrowband filters. As shown in example 1200, the at least one index may include one or more indexes of the narrowband filter(s) (e.g., the BS 110 may indicate the respective indexes for the active narrowband filters). Indicating one or more indexes of the narrowband filter(s) may enable the BS 110 to signal non-consecutive active narrowband filters. As shown in example 1210, the configuration may include an indication of a lowest (or middle, highest, or the like) index of the indexes and an indication of a quantity of the narrowband filter(s) (e.g., the quantity of active narrowband filters). Including the indication of an index (e.g., the lowest index) and the indication of the quantity of the narrowband filter(s) may enable the BS 110 to signal which consecutive active narrowband filters are to be used for the backscattering communications (e.g., without signaling the index for each active narrowband filter).

In example 1220, the identification of the one or more narrowband filters includes a bitmap. For example, each narrowband filter may be mapped to the bitmap, and the bitmap may dynamically indicate which narrowband filter(s) are to be activated. The bitmap may enable the BS 110 to indicate which consecutive or non-consecutive narrowband filters are to be used for the backscattering communications.

With reference to the third aspect, in examples 1230 and 1240, the identification of the narrowband filter(s) includes an indication of one or more subcarriers on which the narrowband filter(s) are configured to operate. For example, the BS 110 may indicate the frequency range of an active subcarrier (e.g., a subcarrier that is used to backscatter information) via a predefined or RRC configuration or dynamically. Including the indication of the subcarrier(s) may enable the UE 120 (e.g., as opposed to the BS 110) to select the appropriate filter based on the indicated frequency or frequency range with reduced signaling overhead.

As shown in example 1230, the indication of the plurality of subcarriers may include an indication of the lowest (or middle, highest, or the like) frequency of the plurality of subcarriers and a highest frequency of the plurality of subcarriers. For example, the BS 110 may indicate the lowest frequency and the highest frequency of the active subcarriers (e.g., the BS 110 may indicate only the lowest frequency and the highest frequency of the active subcarriers). The UE 120 may choose the narrowband filter(s) corresponding to the indicated frequency range (e.g., the frequency range between the lowest frequency and the highest frequency).

As shown in example 1240, the indication of the plurality of subcarriers includes an indication of a lowest (or middle, highest, or the like) frequency of the plurality of subcarriers and a frequency range of the plurality of subcarriers. For examples, the BS 110 may indicate the lowest frequency and frequency range of the active subcarrier (e.g., the BS 110 may indicate only the lowest frequency and frequency range of the active subcarrier). The UE 120 may choose the narrowband filter(s) corresponding to the indicated frequency range.

As indicated above, FIG. 12 is provided as an example. Other examples may differ from what is described with respect to FIG. 12.

In some examples (e.g., where index modulation is not configured), the BS 110 may indicate repetitions per bit. In some examples, each narrowband filter of the plurality of narrowband filters has a respective fixed bandwidth (e.g., the bandwidth(s) of the filter(s) may not be tunable). The configuration may include an indication of a quantity of narrowband filters that are to transmit at least one repeated bit. For example, the BS 110 may indicate whether one narrowband filter or multiple narrowband filters are to be used for one information bit, and if multiple narrowband filters are to be used, then the BS 110 may indicate the quantity of narrowband filters that are to be used for a repeated information bit (e.g., the quantity of narrowband filters per information bit). Including the indication of the quantity of narrowband filters in the configuration may enable the UE 120 to use an appropriate quantity of fixed-bandwidth narrowband filters for backscattering of repeated bits.

The narrowband filters may have tunable bandwidths. The BS 110 may indicate, via the configuration, the quantity of narrowband filters that are to be used for a repeated information bit (e.g., the quantity of narrowband filters per information bit). In some examples, the configuration may include an indication that each narrowband filter is to transmit at least one repeated bit. For example, the configuration may indicate a common repetition for all narrowband filters. Including, in the configuration, the indication that each narrowband filter is to transmit at least one repeated bit may enable the UE 120 to transmit repeated bits in cases where the narrowband filters have the same bandwidth. In some examples, the configuration may include an indication, for each narrowband filter, of whether that narrowband filter is to transmit at least one repeated bit. Including, in the configuration, the indication that each narrowband filter is to transmit at least one repeated bit may enable the UE 120 to transmit repeated bits in cases where different narrowband filters have different bandwidths (e.g., frequencies with deeper fading may have larger cluster sizes and, thus, more repetitions).

As described above, block/cluster/narrowband-based backscattering may be indicated based on block or cluster size (e.g., the bandwidth of the filter) and/or a duration for each bit at each narrowband filter. An indication for index modulation may include a duration for each bit at each narrowband filter and/or a quantity of narrowband filters to be used for the index modulation. In some examples, the quantity of narrowband filters per information bit (e.g., the quantity of narrowband filters that are to be used for the same bit) may be signaled. In some examples, one or more commands described herein (e.g., the configuration) may be transmitted via DCI or as an RRC configuration, and may involve one or more modulation and coding scheme (MCS) tables (e.g., tables 1100, 1110, and/or 1120).

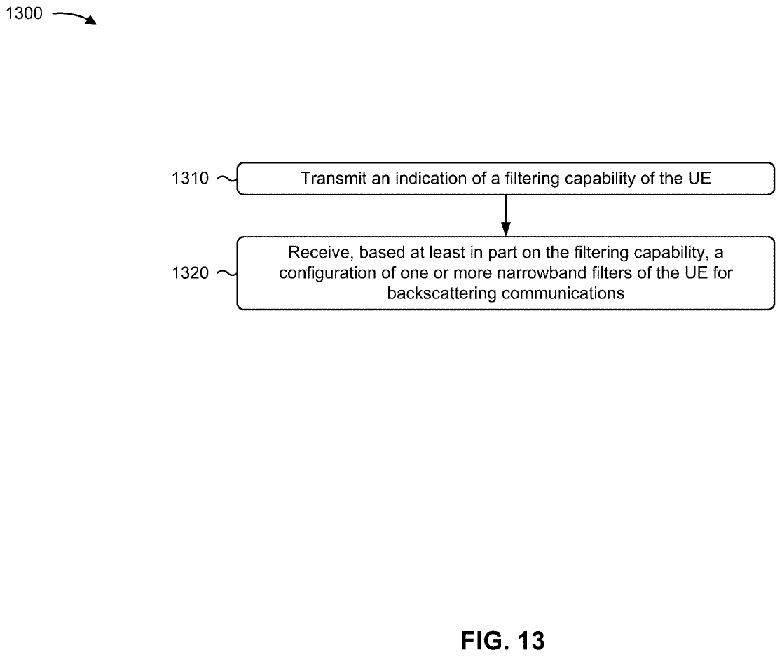

FIG. 13 shows a method 1300 for wireless communications by a UE, such as UE 120.

Method 1300 begins at step 1310 with transmitting an indication of a filtering capability of the UE.

Method 1300 then proceeds to step 1320 with receiving, based at least in part on the filtering capability, a configuration of one or more narrowband filters of the UE for backscattering communications.

In one aspect, the configuration is for the one or more narrowband filters to perform the backscattering communications using index modulation.

In one aspect, the configuration is for the one or more narrowband filters to perform the backscattering communications based at least in part on an energy status of the UE.

In one aspect, the configuration is for the one or more narrowband filters to perform a parity check using the index modulation.

In one aspect, the configuration is for the one or more narrowband filters to perform data transmission using the index modulation.

In one aspect, the configuration includes an indication of a quantity of bits that are to be transmitted using the index modulation.

In one aspect, the indication of the quantity of the bits includes an indication of a quantity of at least one narrowband filter, of the one or more narrowband filters, that is to transmit at least one of the bits.

In one aspect, the indication of the quantity of the bits is an explicit indication of the quantity of the bits.

In one aspect, the configuration includes an indication of a duration of the data transmission.

In one aspect, the indication of the duration of the data transmission includes an explicit indication of the duration of the data transmission.

In one aspect, the indication of the duration of the data transmission is an indication of a ratio of the duration of the data transmission and a reference duration.

In one aspect, the configuration is based at least in part on one or more of a first table that includes one or more first parameters associated with repeated bits, or a second table that includes one or more second parameters associated with index modulation.

In one aspect, the configuration is based at least in part on a table that includes one or more first parameters associated with repeated bits and one or more second parameters associated with index modulation.

In one aspect, the configuration is based at least in part on an identification of the one or more narrowband filters.

In one aspect, the identification of the one or more narrowband filters is based at least in part on a rule for the identification of the one or more narrowband filters.

In one aspect, the configuration includes the identification of the one or more narrowband filters.

In one aspect, the identification of the one or more narrowband filters includes an indication of at least one index of at least one narrowband filter of the one or more narrowband filters.

In one aspect, the at least one index includes one or more indexes of the one or more narrowband filters.

In one aspect, the one or more narrowband filters include a plurality of narrowband filters, the one or more indexes include a plurality of indexes of the plurality of narrowband filters, the at least one index includes a lowest index of the plurality of indexes, and the configuration further includes an indication of a quantity of the one or more narrowband filters.

In one aspect, the identification of the one or more narrowband filters includes a bitmap.

In one aspect, the identification of the one or more narrowband filters includes an indication of one or more subcarriers on which the one or more narrowband filters are configured to operate.

In one aspect, the one or more narrowband filters include a plurality of narrowband filters, the one or more subcarriers include a plurality of subcarriers on which the plurality of narrowband filters are configured to operate, the indication of the plurality of subcarriers includes an indication of a lowest frequency of the plurality of subcarriers and a highest frequency of the plurality of subcarriers.

In one aspect, the one or more narrowband filters include a plurality of narrowband filters, the one or more subcarriers include a plurality of subcarriers on which the plurality of narrowband filters are configured to operate, and the indication of the plurality of subcarriers includes an indication of a lowest frequency of the plurality of subcarriers and a frequency range of the plurality of subcarriers.

In one aspect, the one or more narrowband filters include a plurality of narrowband filters having a plurality of tunable bandwidths, and the configuration includes an indication that each narrowband filter of the plurality of narrowband filters is to transmit at least one repeated bit.

In one aspect, the one or more narrowband filters include a plurality of narrowband filters having a plurality of tunable bandwidths, and the configuration includes an indication, for each narrowband filter of the plurality of narrowband filters, of whether that narrowband filter is to transmit at least one repeated bit.

In one aspect, the UE is an ambient IoT device.

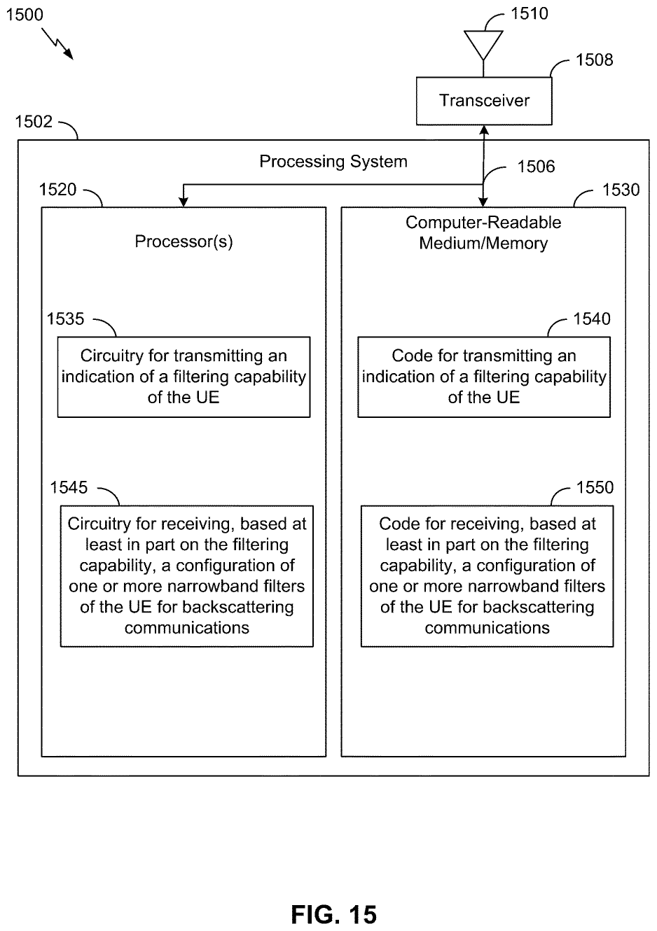

In one aspect, method 1300, or any aspect related to it, may be performed by an apparatus, such as communications device 1500 of FIG. 15, which includes various components operable, configured, or adapted to perform the method 1300.

Communications device 1500 is described below in further detail.

Note that FIG. 13 is just one example of a method, and other methods including fewer, additional, or alternative steps are possible consistent with this disclosure.

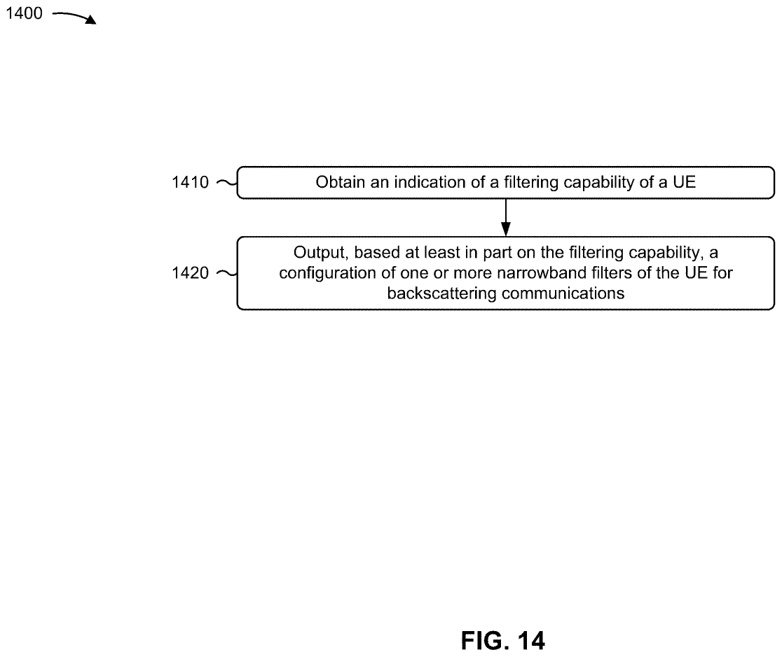

FIG. 14 shows a method 1400 for wireless communications by a network entity, such as BS 110, or a disaggregated base station as discussed with respect to FIG. 3.

Method 1400 begins at step 1410 with obtaining an indication of a filtering capability of a UE.

Method 1400 then proceeds to step 1420 with outputting, based at least in part on the filtering capability, a configuration of one or more narrowband filters of the UE for backscattering communications.

In one aspect, the configuration is for the one or more narrowband filters to perform the backscattering communications using index modulation.

In one aspect, the configuration is for the one or more narrowband filters to perform the backscattering communications based at least in part on an energy status of the UE.

In one aspect, the configuration is for the one or more narrowband filters to perform a parity check using the index modulation.

In one aspect, the configuration is for the one or more narrowband filters to perform data transmission using the index modulation.

In one aspect, the configuration includes an indication of a quantity of bits that are to be transmitted using the index modulation.

In one aspect, the indication of the quantity of the bits includes an indication of a quantity of at least one narrowband filter, of the one or more narrowband filters, that is to transmit at least one of the bits.

In one aspect, the indication of the quantity of the bits is an explicit indication of the quantity of the bits.

In one aspect, the configuration includes an indication of a duration of the data transmission.

In one aspect, the indication of the duration of the data transmission includes an explicit indication of the duration of the data transmission.

In one aspect, the indication of the duration of the data transmission is an indication of a ratio of the duration of the data transmission and a reference duration.

In one aspect, the configuration is based at least in part on one or more of a first table that includes one or more first parameters associated with repeated bits, or a second table that includes one or more second parameters associated with index modulation.

In one aspect, the configuration is based at least in part on a table that includes one or more first parameters associated with repeated bits and one or more second parameters associated with index modulation.

In one aspect, the configuration is based at least in part on an identification of the one or more narrowband filters.

In one aspect, the identification of the one or more narrowband filters is based at least in part on a rule for the identification of the one or more narrowband filters.

In one aspect, the configuration includes the identification of the one or more narrowband filters.

In one aspect, the identification of the one or more narrowband filters includes an indication of at least one index of at least one narrowband filter of the one or more narrowband filters.

In one aspect, the at least one index includes one or more indexes of the one or more narrowband filters.

In one aspect, the one or more narrowband filters include a plurality of narrowband filters, the one or more indexes include a plurality of indexes of the plurality of narrowband filters, the at least one index includes a lowest index of the plurality of indexes, and the configuration further includes an indication of a quantity of the one or more narrowband filters.

In one aspect, the identification of the one or more narrowband filters includes a bitmap.

In one aspect, the identification of the one or more narrowband filters includes an indication of one or more subcarriers on which the one or more narrowband filters are configured to operate.

In one aspect, the one or more narrowband filters include a plurality of narrowband filters, the one or more subcarriers include a plurality of subcarriers on which the plurality of narrowband filters are configured to operate, the indication of the plurality of subcarriers includes an indication of a lowest frequency of the plurality of subcarriers and a highest frequency of the plurality of subcarriers.

In one aspect, the one or more narrowband filters include a plurality of narrowband filters, the one or more subcarriers include a plurality of subcarriers on which the plurality of narrowband filters are configured to operate, and the indication of the plurality of subcarriers includes an indication of a lowest frequency of the plurality of subcarriers and a frequency range of the plurality of subcarriers.

In one aspect, the one or more narrowband filters include a plurality of narrowband filters having a plurality of tunable bandwidths, and the configuration includes an indication that each narrowband filter of the plurality of narrowband filters is to transmit at least one repeated bit.

In one aspect, the one or more narrowband filters include a plurality of narrowband filters having a plurality of tunable bandwidths, and the configuration includes an indication, for each narrowband filter of the plurality of narrowband filters, of whether that narrowband filter is to transmit at least one repeated bit.

In one aspect, the UE is an ambient IoT device.

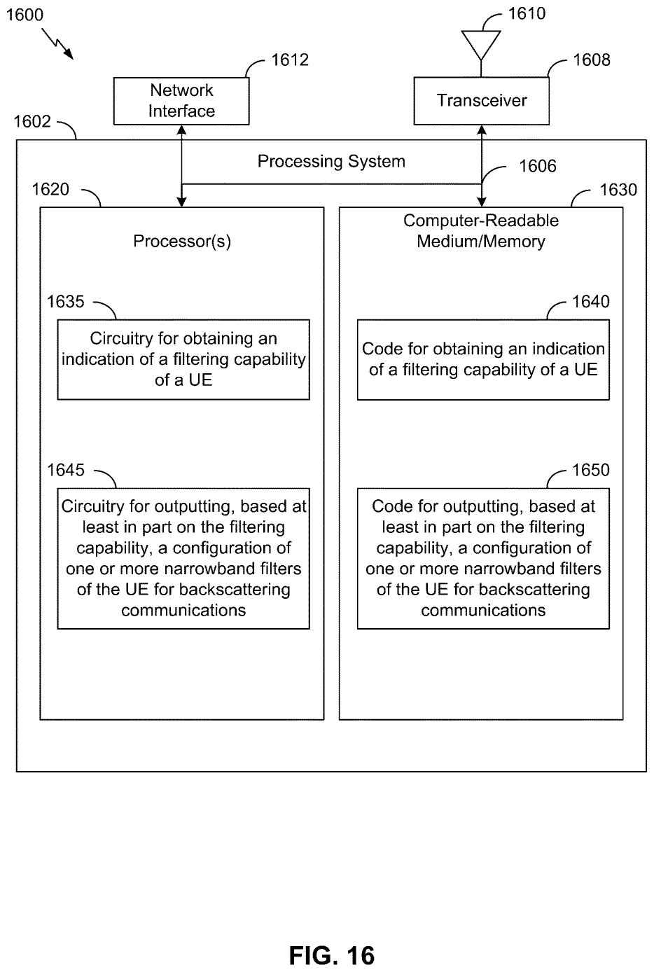

In one aspect, method 1400, or any aspect related to it, may be performed by an apparatus, such as communications device 1600 of FIG. 16, which includes various components operable, configured, or adapted to perform the method 1400.

Communications device 1600 is described below in further detail.

Note that FIG. 14 is just one example of a method, and other methods including fewer, additional, or alternative steps are possible consistent with this disclosure.

FIG. 15 is a diagram illustrating an example of an implementation of code and circuitry for a communications device 1500, in accordance with the present disclosure. The communications device 1500 may be a UE, or a UE may include the communications device 1500.

The communications device 1500 includes a processing system 1502 coupled to a transceiver 1508 (e.g., a transmitter and/or a receiver). The transceiver 1508 is configured to transmit and receive signals for the communications device 1500 via an antenna 1510, such as the various signals as described herein. The processing system 1502 may be configured to perform processing functions for the communications device 1500, including processing signals received and/or to be transmitted by the communications device 1500.

The processing system 1502 includes one or more processors 1520. In various aspects, the one or more processors 1520 may be representative of one or more of receive processor 258, transmit processor 264, TX MIMO processor 266, and/or controller/processor 280, as described with respect to FIG. 2. The one or more processors 1520 are coupled to a computer-readable medium/memory 1530 via a bus 1506. In various aspects, the computer-readable medium/memory 1530 may be representative of memory 282, as described with respect to FIG. 2. In certain aspects, the computer-readable medium/memory 1530 is configured to store instructions (e.g., computer-executable code, processor-executable code) that when executed by the one or more processors 1520, cause the one or more processors 1520 to perform the method 1300 described with respect to FIG. 13, or any aspect related to it. Note that reference to a processor performing a function of communications device 1500 may include one or more processors performing that function of communications device 1500.

As shown in FIG. 15, the communications device 1500 may include circuitry for transmitting an indication of a filtering capability of the UE (circuitry 1535).

As shown in FIG. 15, the communications device 1500 may include, stored in computer-readable medium/memory 1530, code for transmitting an indication of a filtering capability of the UE (code 1540).

As shown in FIG. 15, the communications device 1500 may include circuitry for receiving, based at least in part on the filtering capability, a configuration of one or more narrowband filters of the UE for backscattering communications (circuitry 1545).

As shown in FIG. 15, the communications device 1500 may include, stored in computer-readable medium/memory 1530, code for receiving, based at least in part on the filtering capability, a configuration of one or more narrowband filters of the UE for backscattering communications (code 1550).

Various components of the communications device 1500 may provide means for performing the method 1300 described with respect to FIG. 13, or any aspect related to it. For example, means for transmitting, sending, or outputting for transmission may include the transceiver(s) 254 and/or antenna(s) 252 of the UE 120 and/or transceiver 1508 and antenna 1510 of the communications device 1500 in FIG. 15. Means for receiving or obtaining may include the transceiver(s) 254 and/or antenna(s) 252 of the UE 120 and/or transceiver 1508 and antenna 1510 of the communications device 1500 in FIG. 15.

FIG. 15 is provided as an example. Other examples may differ from what is described in connection with FIG. 15.

FIG. 16 is a diagram illustrating an example of an implementation of code and circuitry for a communications device 1600, in accordance with the present disclosure. The communications device 1600 may be a network entity (such as BS 110 or a disaggregated base station as described with regard to FIG. 3), or a network entity may include the communications device 1600.

The communications device 1600 includes a processing system 1602 coupled to a transceiver 1608 (e.g., a transmitter and/or a receiver). The transceiver 1608 is configured to transmit and receive signals for the communications device 1600 via an antenna 1610, such as the various signals as described herein. The network interface 1612 is configured to obtain and send signals for the communications device 1600 via communications link(s), such as a backhaul link, midhaul link, and/or fronthaul link as described herein, such as with respect to FIG. 3. The processing system 1602 may be configured to perform processing functions for the communications device 1600, including processing signals received and/or to be transmitted by the communications device 1600.

The processing system 1602 includes one or more processors 1620. In various aspects, the one or more processors 1620 may be representative of one or more of receive processor 238, transmit processor 220, TX MIMO processor 230, and/or controller/processor 240, as described with respect to FIG. 2. The one or more processors 1620 are coupled to a computer-readable medium/memory 1630 via a bus 1606. In various aspects, the computer-readable medium/memory 1630 may be representative of memory 242, as described with respect to FIG. 2. In certain aspects, the computer-readable medium/memory 1630 is configured to store instructions (e.g., computer-executable code, processor-executable code) that when executed by the one or more processors 1620, cause the one or more processors 1620 to perform the method 1400 described with respect to FIG. 14, or any aspect related to it. Note that reference to a processor performing a function of communications device 1600 may include one or more processors performing that function of communications device 1600.

As shown in FIG. 16, the communications device 1600 may include circuitry for obtaining an indication of a filtering capability of a UE (circuitry 1635).

As shown in FIG. 16, the communications device 1600 may include, stored in computer-readable medium/memory 1630, code for obtaining an indication of a filtering capability of a UE (code 1640).

As shown in FIG. 16, the communications device 1600 may include circuitry for outputting, based at least in part on the filtering capability, a configuration of one or more narrowband filters of the UE for backscattering communications (circuitry 1645).

As shown in FIG. 16, the communications device 1600 may include, stored in computer-readable medium/memory 1630, code for outputting, based at least in part on the filtering capability, a configuration of one or more narrowband filters of the UE for backscattering communications (code 1650).

Various components of the communications device 1600 may provide means for performing the method 1400 described with respect to FIG. 14, or any aspect related to it. For example, means for transmitting, sending, or outputting for transmission may include the transceiver(s) 232 and/or antenna(s) 234 of the BS 110 and/or transceiver 1608 and antenna 1610 of the communications device 1600 in FIG. 16. Means for receiving or obtaining may include the transceiver(s) 232 and/or antenna(s) 234 of the BS 110 and/or transceiver 1608 and antenna 1610 of the communications device 1600 in FIG. 16.

FIG. 16 is provided as an example. Other examples may differ from what is described in connection with FIG. 16.

The following provides an overview of some Aspects of the present disclosure:

Aspect 1: A method of wireless communication performed by a UE, comprising: transmitting an indication of a filtering capability of the UE; and receiving, based at least in part on the filtering capability, a configuration of one or more narrowband filters of the UE for backscattering communications.

Aspect 2: The method of Aspect 1, wherein the configuration is for the one or more narrowband filters to perform the backscattering communications using index modulation.

Aspect 3: The method of Aspect 2, wherein the configuration is for the one or more narrowband filters to perform the backscattering communications based at least in part on an energy status of the UE.
Aspect 4: The method of Aspect 2, wherein the configuration is for the one or more narrowband filters to perform a parity check using the index modulation.

Aspect 5: The method of Aspect 2, wherein the configuration is for the one or more narrowband filters to perform data transmission using the index modulation.

Aspect 6: The method of Aspect 5, wherein the configuration includes an indication of a quantity of bits that are to be transmitted using the index modulation.

Aspect 7: The method of Aspect 6, wherein the indication of the quantity of the bits includes an indication of a quantity of at least one narrowband filter, of the one or more narrowband filters, that is to transmit at least one of the bits.

Aspect 8: The method of Aspect 6, wherein the indication of the quantity of the bits is an explicit indication of the quantity of the bits.

Aspect 9: The method of Aspect 5, wherein the configuration includes an indication of a duration of the data transmission.

Aspect 10: The method of Aspect 9, wherein the indication of the duration of the data transmission includes an explicit indication of the duration of the data transmission.

Aspect 11: The method of Aspect 9, wherein the indication of the duration of the data transmission is an indication of a ratio of the duration of the data transmission and a reference duration.

Aspect 12: The method of any of Aspects 1-11, wherein the configuration is based at least in part on one or more of a first table that includes one or more first parameters associated with repeated bits, or a second table that includes one or more second parameters associated with index modulation.

Aspect 13: The method of any of Aspects 1-12, wherein the configuration is based at least in part on a table that includes one or more first parameters associated with repeated bits and one or more second parameters associated with index modulation.

Aspect 14: The method of any of Aspects 1-13, wherein the configuration is based at least in part on an identification of the one or more narrowband filters.

Aspect 15: The method of Aspect 14, wherein the identification of the one or more narrowband filters is based at least in part on a rule for the identification of the one or more narrowband filters.

Aspect 16: The method of Aspect 14, wherein the configuration includes the identification of the one or more narrowband filters.

Aspect 17: The method of Aspect 16, wherein the identification of the one or more narrowband filters includes an indication of at least one index of at least one narrowband filter of the one or more narrowband filters.

Aspect 18: The method of Aspect 17, wherein the at least one index includes one or more indexes of the one or more narrowband filters.

Aspect 19: The method of Aspect 17, wherein the one or more narrowband filters include a plurality of narrowband filters, wherein the one or more indexes include a plurality of indexes of the plurality of narrowband filters, wherein the at least one index includes a lowest index of the plurality of indexes, and wherein the configuration further includes an indication of a quantity of the one or more narrowband filters.

Aspect 20: The method of Aspect 16, wherein the identification of the one or more narrowband filters includes a bitmap.

Aspect 21: The method of Aspect 14, wherein the identification of the one or more narrowband filters includes an indication of one or more subcarriers on which the one or more narrowband filters are configured to operate.

Aspect 22: The method of Aspect 21, wherein the one or more narrowband filters include a plurality of narrowband filters, wherein the one or more subcarriers include a plurality of subcarriers on which the plurality of narrowband filters are configured to operate, wherein the indication of the plurality of subcarriers includes an indication of a lowest frequency of the plurality of subcarriers and a highest frequency of the plurality of subcarriers.

Aspect 23: The method of Aspect 21, wherein the one or more narrowband filters include a plurality of narrowband filters, wherein the one or more subcarriers include a plurality of subcarriers on which the plurality of narrowband filters are configured to operate, wherein the indication of the plurality of subcarriers includes an indication of a lowest frequency of the plurality of subcarriers and a frequency range of the plurality of subcarriers.

Aspect 24: The method of any of Aspects 1-23, wherein the one or more narrowband filters include a plurality of narrowband filters, wherein each narrowband filter of the plurality of narrowband filters has a respective fixed bandwidth, and wherein the configuration includes an indication of a quantity of the plurality of narrowband filters that are to transmit at least one repeated bit.

Aspect 25: The method of any of Aspects 1-24, wherein the one or more narrowband filters include a plurality of narrowband filters having a plurality of tunable bandwidths, and wherein the configuration includes an indication that each narrowband filter of the plurality of narrowband filters is to transmit at least one repeated bit.

Aspect 26: The method of any of Aspects 1-25, wherein the one or more narrowband filters include a plurality of narrowband filters having a plurality of tunable bandwidths, and wherein the configuration includes an indication, for each narrowband filter of the plurality of narrowband filters, of whether that narrowband filter is to transmit at least one repeated bit.

Aspect 27: The method of any of Aspects 1-26, wherein the UE is an ambient IoT device.

Aspect 28: A method of wireless communication performed by a network entity, comprising: obtaining an indication of a filtering capability of a UE; and outputting, based at least in part on the filtering capability, a configuration of one or more narrowband filters of the UE for backscattering communications.

Aspect 29: The method of Aspect 28, wherein the configuration is for the one or more narrowband filters to perform the backscattering communications using index modulation.

Aspect 30: The method of Aspect 29, wherein the configuration is for the one or more narrowband filters to perform the backscattering communications based at least in part on an energy status of the UE.

Aspect 31: The method of Aspect 29, wherein the configuration is for the one or more narrowband filters to perform a parity check using the index modulation.

Aspect 32: The method of Aspect 29, wherein the configuration is for the one or more narrowband filters to perform data transmission using the index modulation.

Aspect 33: The method of Aspect 32, wherein the configuration includes an indication of a quantity of bits that are to be transmitted using the index modulation.

Aspect 34: The method of Aspect 33, wherein the indication of the quantity of the bits includes an indication of a quantity of at least one narrowband filter, of the one or more narrowband filters, that is to transmit at least one of the bits.

Aspect 35: The method of Aspect 33, wherein the indication of the quantity of the bits is an explicit indication of the quantity of the bits.

Aspect 36: The method of Aspect 32, wherein the configuration includes an indication of a duration of the data transmission.

Aspect 37: The method of Aspect 36, wherein the indication of the duration of the data transmission includes an explicit indication of the duration of the data transmission.

Aspect 38: The method of Aspect 36, wherein the indication of the duration of the data transmission is an indication of a ratio of the duration of the data transmission and a reference duration.

Aspect 39: The method of any of Aspects 28-38, wherein the configuration is based at least in part on one or more of a first table that includes one or more first parameters associated with repeated bits, or a second table that includes one or more second parameters associated with index modulation.

Aspect 40: The method of any of Aspects 28-39, wherein the configuration is based at least in part on a table that includes one or more first parameters associated with repeated bits and one or more second parameters associated with index modulation.

Aspect 41: The method of any of Aspects 28-40, wherein the configuration is based at least in part on an identification of the one or more narrowband filters.

Aspect 42: The method of Aspect 41, wherein the identification of the one or more narrowband filters is based at least in part on a rule for the identification of the one or more narrowband filters.

Aspect 43: The method of Aspect 41, wherein the configuration includes the identification of the one or more narrowband filters.

Aspect 44: The method of Aspect 43, wherein the identification of the one or more narrowband filters includes an indication of at least one index of at least one narrowband filter of the one or more narrowband filters.

Aspect 45: The method of Aspect 44, wherein the at least one index includes one or more indexes of the one or more narrowband filters.

Aspect 46: The method of Aspect 44, wherein the one or more narrowband filters include a plurality of narrowband filters, wherein the one or more indexes include a plurality of indexes of the plurality of narrowband filters, wherein the at least one index includes a lowest index of the plurality of indexes, and wherein the configuration further includes an indication of a quantity of the one or more narrowband filters.

Aspect 47: The method of Aspect 43, wherein the identification of the one or more narrowband filters includes a bitmap.

Aspect 48: The method of Aspect 41, wherein the identification of the one or more narrowband filters includes an indication of one or more subcarriers on which the one or more narrowband filters are configured to operate.

Aspect 49: The method of Aspect 48, wherein the one or more narrowband filters include a plurality of narrowband filters, wherein the one or more subcarriers include a plurality of subcarriers on which the plurality of narrowband filters are configured to operate, wherein the indication of the plurality of subcarriers includes an indication of a lowest frequency of the plurality of subcarriers and a highest frequency of the plurality of subcarriers.

Aspect 50: The method of Aspect 48, wherein the one or more narrowband filters include a plurality of narrowband filters, wherein the one or more subcarriers include a plurality of subcarriers on which the plurality of narrowband filters are configured to operate, wherein the indication of the plurality of subcarriers includes an indication of a lowest frequency of the plurality of subcarriers and a frequency range of the plurality of subcarriers.

Aspect 51: The method of any of Aspects 28-50, wherein the one or more narrowband filters include a plurality of narrowband filters, wherein each narrowband filter of the plurality of narrowband filters has a respective fixed bandwidth, and wherein the configuration includes an indication of a quantity of the plurality of narrowband filters that are to transmit at least one repeated bit.

Aspect 52: The method of any of Aspects 28-51, wherein the one or more narrowband filters include a plurality of narrowband filters having a plurality of tunable bandwidths, and wherein the configuration includes an indication that each narrowband filter of the plurality of narrowband filters is to transmit at least one repeated bit.

Aspect 53: The method of any of Aspects 28-52, wherein the one or more narrowband filters include a plurality of narrowband filters having a plurality of tunable bandwidths, and wherein the configuration includes an indication, for each narrowband filter of the plurality of narrowband filters, of whether that narrowband filter is to transmit at least one repeated bit.

Aspect 54: The method of any of Aspects 28-53, wherein the UE is an ambient IoT device.

Aspect 55: An apparatus for wireless communication at a device, comprising a processor; memory coupled with the processor; and instructions stored in the memory and executable by the processor to cause the apparatus to perform the method of one or more of Aspects 1-54.

Aspect 56: A device for wireless communication, comprising a memory and one or more processors coupled to the memory, the one or more processors configured to perform the method of one or more of Aspects 1-54

Aspect 57: An apparatus for wireless communication, comprising at least one means for performing the method of one or more of Aspects 1-54.

Aspect 58: A non-transitory computer-readable medium storing code for wireless communication, the code comprising instructions executable by a processor to perform the method of one or more of Aspects 1-54.

Aspect 59: A non-transitory computer-readable medium storing a set of instructions for wireless communication, the set of instructions comprising one or more instructions that, when executed by one or more processors of a device, cause the device to perform the method of one or more of Aspects 1-54.

The foregoing disclosure provides illustration and description but is not intended to be exhaustive or to limit the aspects to the precise forms disclosed.

Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules, and circuits described in connection with the present disclosure may be implemented or performed with a general purpose processor, a digital signal processor (DSP), an application-specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices (e.g., a combination of a DSP and a microprocessor, a plurality of microprocessors, one or more microprocessors in conjunction with a DSP core, a system on a chip (SoC), or any other such configuration).

As used herein, the term “determining” encompasses a wide variety of actions. For example, “determining” may include calculating, computing, processing, deriving, investigating, looking up (e.g., looking up in a table, a database, or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or a processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for”. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. A user equipment (UE) for wireless communication, comprising:
a memory; and
one or more processors coupled to the memory and configured to cause the UE to:
transmit an indication of a filtering capability of the UE; and
receive, based at least in part on the filtering capability, a configuration of one or more narrowband filters of the UE for backscattering communications.

2. The UE of claim 1, wherein the configuration is for the one or more narrowband filters to perform the backscattering communications using index modulation.

3. (canceled)

4. (canceled)

5. The UE of claim 2, wherein the configuration is for the one or more narrowband filters to perform data transmission using the index modulation, or wherein the configuration is for the one or more narrowband filters to perform the backscattering communications based at least in part on an energy status of the UE, or wherein the configuration is for the one or more narrowband filters to perform a parity check using the index modulation.

6. The UE of claim 5, wherein the configuration is for the one or more narrowband filters to perform data transmission using the index modulation, and wherein the configuration includes an indication of a quantity of bits that are to be transmitted using the index modulation, and wherein:
the indication of the quantity of the bits includes an indication of a quantity of at least one narrowband filter, of the one or more narrowband filters, that is to transmit at least one of the bits; or
the indication of the quantity of the bits is an explicit indication of the quantity of the bits.

7. (canceled)

8. (canceled)

9. The UE of claim 5, wherein the configuration is for the one or more narrowband filters to perform data transmission using the index modulation, and wherein the configuration includes an indication of a duration of the data transmission, and wherein:
the indication of the duration of the data transmission includes an explicit indication of the duration of the data transmission; or
the indication of the duration of the data transmission is an indication of a ratio of the duration of the data transmission and a reference duration.

10. (canceled)

11. (canceled)

12. The UE of claim 1, wherein the configuration is based at least in part on one or more of a first table that includes one or more first parameters associated with repeated bits, or a second table that includes one or more second parameters associated with index modulation.

13. The UE of claim 1, wherein the configuration is based at least in part on a table that includes one or more first parameters associated with repeated bits and one or more second parameters associated with index modulation.

14. The UE of claim 1, wherein the configuration is based at least in part on an identification of the one or more narrowband filters.

15. The UE of claim 14, wherein the identification of the one or more narrowband filters is based at least in part on a rule for the identification of the one or more narrowband filters.

16. The UE of claim 14, wherein the configuration includes the identification of the one or more narrowband filters, and wherein the identification of the one or more narrowband filters includes an indication of at least one index of at least one narrowband filter of the one or more narrowband filters.

17. (canceled)

18. The UE of claim 17, wherein the at least one index includes one or more indexes of the one or more narrowband filters.

19. The UE of claim 17, wherein the one or more narrowband filters include a plurality of narrowband filters, wherein the one or more indexes include a plurality of indexes of the plurality of narrowband filters, wherein the at least one index includes a lowest index of the plurality of indexes, and wherein the configuration further includes an indication of a quantity of the one or more narrowband filters.

20. The UE of claim 16, wherein the identification of the one or more narrowband filters includes a bitmap.

21. The UE of claim 14, wherein the identification of the one or more narrowband filters includes an indication of one or more subcarriers on which the one or more narrowband filters are configured to operate, and wherein:
the one or more narrowband filters include a plurality of narrowband filters, wherein the one or more subcarriers include a plurality of subcarriers on which the plurality of narrowband filters are configured to operate, wherein the indication of the plurality of subcarriers includes an indication of a lowest frequency of the plurality of subcarriers and a highest frequency of the plurality of subcarriers; or
the one or more narrowband filters include a plurality of narrowband filters, wherein the one or more subcarriers include a plurality of subcarriers on which the plurality of narrowband filters are configured to operate, wherein the indication of the plurality of subcarriers includes an indication of a lowest frequency of the plurality of subcarriers and a frequency range of the plurality of subcarriers.

22. (canceled)

23. (canceled)

24. The UE of claim 1, wherein the one or more narrowband filters include a plurality of narrowband filters, wherein each narrowband filter of the plurality of narrowband filters has a respective fixed bandwidth, and wherein the configuration includes an indication of a quantity of the plurality of narrowband filters that are to transmit at least one repeated bit.

25. The UE of claim 1, wherein the one or more narrowband filters include a plurality of narrowband filters having a plurality of tunable bandwidths, and wherein the configuration includes an indication that each narrowband filter of the plurality of narrowband filters is to transmit at least one repeated bit.

26. The UE of claim 1, wherein the one or more narrowband filters include a plurality of narrowband filters having a plurality of tunable bandwidths, and wherein the configuration includes an indication, for each narrowband filter of the plurality of narrowband filters, of whether that narrowband filter is to transmit at least one repeated bit.

27. The UE of claim 1, wherein the UE is an ambient internet of things device.

28. A network entity for wireless communication, comprising:
a memory; and
one or more processors coupled to the memory and configured to cause the network entity to:
obtain an indication of a filtering capability of a user equipment (UE); and
output, based at least in part on the filtering capability, a configuration of one or more narrowband filters of the UE for backscattering communications.

29. A method of wireless communication performed by a user equipment (UE), comprising:
transmitting an indication of a filtering capability of the UE; and
receiving, based at least in part on the filtering capability, a configuration of one or more narrowband filters of the UE for backscattering communications.

30. (canceled)
